(19) United States
(12) Patent Application Publication
(10) Pub. No.: US 2016/0366077 A1
(43) Pub. Date: Dec. 15, 2016

(54) E-MAIL PROCESSING

(71) Applicant: Alibaba Group Holding Limited, Grand Cayman (KY)

(72) Inventors: Guangqian Dong, Hangzhou (CN); Zhenhao WU, Hangzhou (CN); Lei Weng, Hangzhou (CN); Hang Chen, Hangzhou (CN)

(21) Appl. No.: 15/182,446

(22) Filed: Jun. 14, 2016

(30) Foreign Application Priority Data
Jun. 15, 2015 (CN) 201510329057.0
Jun. 16, 2015 (CN) 201510334436.9

(51) Int. Cl. H04L 12/58

(52) U.S. Cl. CPC H04L 51/066; H04L 51/04; H04L 51/24

(57) ABSTRACT

An e-mail processing method includes: receiving, by a server, an e-mail from a sender; if there exists a recipient that has not yet been associated with an e-mail account in the recipients of the e-mail, allocating, by the server, an e-mail account to the recipient; and sending the e-mail to the allocated e-mail account, thereby ensuring that the recipient successfully receives an e-mail of a sender and improving communication efficiency between users. An e-mail group creating method includes: detecting, by a server, an e-mail group creating demand for an instant messaging group; extracting, by the server, an e-mail address corresponding to each member contained in the instant messaging group; and generating a corresponding e-mail group, thereby automatically creating an e-mail group and helping to simplify a user's operation.

### CROSS REFERENCE TO RELATED APPLICATIONS

The present disclosure claims the benefit of Chinese Patent Application Number 201510329057.0 filed 15 Jun. 2015, entitled “Method, Apparatus, and System for E-mail Processing” and Chinese Patent Application Number 201510334436.9 filed 16 Jun. 2015, entitled “Method and Apparatus for Creating E-mail Group,” which are hereby incorporated by reference in its entirety.

### TECHNICAL FIELD

The present disclosure relates to the field of Internet technologies, and, more particularly, to an e-mail processing method, apparatus and system. The present disclosure also relates to the field of communication technologies, and, more particularly, to a method and apparatus for creating an e-mail group.

### BACKGROUND

With the development of Internet technologies, there are more and more ways to communicate between people. Instant Messaging (IM) is the most popular way to communicate on the Internet at present, and a variety of IM software have emerged one after another; service providers also provide increasingly rich communication service functions. For example, the communication content may include a text, an interface, a voice, a video, a file, etc.

In an actual application, some users are accustomed to using e-mails for communication. With respect to a user accustomed to using e-mails for communication, when the user sends an e-mail to an IM user, if the IM user has not been associated with an e-mail account, the IM user cannot receive the e-mail, thereby resulting in unsuccessful information transmission, which affects communication efficiency between the users.

In a user's daily office work process, it is often necessary to use e-mail to conduct mutual communication, business announcements and so on. When the user needs to send e-mails with the same content to many other users at the same time, the user may establish a unified e-mail group for the other users, thus avoiding the necessity of entering each receiver's email address repeatedly and helping to simplify the user's operation.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “technique(s) or technical solution(s)” for instance, may refer to apparatus(s), system(s), method(s) and/or computer-readable instructions as permitted by the context above and throughout the present disclosure.

According to multiple aspects of the present disclosure, an e-mail processing method, apparatus and system are provided to solve the problem that an IM user cannot receive an e-mail and improve communication efficiency between users.

In one aspect of the present disclosure, a mail processing method is provided, including:

receiving, by a server, an e-mail from a sender; and

if there exists a recipient that has not yet been associated with an e-mail account in the recipients of the e-mail, allocating, by the server, an e-mail account to the recipient that has not yet been associated with an e-mail account, and sending the e-mail to the allocated e-mail account.

In another aspect of the present disclosure, an e-mail processing apparatus is provided, which is implemented in a server. The apparatus includes:

a receiving module that receives an e-mail from a sender;

an allocation module that, if there exists a recipient that has not yet been associated with an e-mail account in the recipients of the e-mail, allocates an e-mail account to the recipient that has not yet been associated with an e-mail account; and

a sending module that sends the e-mail to the e-mail account allocated by the allocation module.

In a further aspect of the present disclosure, a mail processing apparatus is provided, which is located in a receiving-end IM client terminal. The receiving-end IM client terminal is an IM client terminal of a recipient, and includes:

a receiving module that receives a mail notification message sent by a server; and

an acquisition module that logs into an e-mail account where the e-mail is located according to the mail notification message, to acquire the e-mail, the e-mail account being temporarily allocated by the server to the recipient.

In a further aspect of the present disclosure, a mail processing apparatus is provided, which is implemented in a sending-end IM client terminal. The sending-end IM client terminal is an IM client terminal of a sender, and includes:

an acquisition module that acquires content of an e-mail;

a determination module that determines a recipient of the e-mail, the recipient of the e-mail being determined according to a contact group; and

a generation module that generates the e-mail according to the content of the e-mail and the recipient of the e-mail.

In a further aspect of the present disclosure, a mail processing system is provided that includes a server, a sending-end IM client terminal and a receiving-end IM client terminal. The sending-end IM client terminal is an IM client terminal of a sender; and the receiving-end IM client terminal is an IM client terminal of a recipient.

The sending-end IM client terminal generates an e-mail, and sends the e-mail to the server.

The server receives the e-mail, and if there exists a recipient that has not yet been associated with an e-mail account in the recipients of the e-mail, allocates an e-mail account to the recipient that has not yet been associated with an e-mail account, sends the e-mail to the allocated e-mail account, and sends a mail notification message to the receiving-end IM client terminal.

The receiving-end IM client terminal receives the mail notification message sent by the server, and logs into the allocated e-mail account according to the mail notification message, to acquire the e-mail.

In the present disclosure, a server receives an e-mail from a sender. If there exists a recipient that has not yet been associated with an e-mail account in the recipients of the e-mail, the server allocates an e-mail account to the recipient that has not yet been associated with an e-mail account, and sends the e-mail to the allocated e-mail account, thus ensuring that a recipient successfully receive an e-mail of a sender, which solves the problem that an e-mail cannot be received and improves communication efficiency between users.

The present disclosure also provides a method and apparatus for creating an e-mail group, which may automatically create an e-mail group, thereby helping to simplify a user's operation.

In order to achieve the foregoing objective, the present disclosure provides technical solutions as follows:

A method for creating an e-mail group is provided, which includes:

detecting, by a server, an e-mail group creating demand for an instant messaging group;

extracting, by the server, an e-mail address corresponding to each member according to members contained in the instant messaging group; and

collecting, by the server, the e-mail addresses corresponding to all of the members in the instant messaging group, and generating a corresponding e-mail group. When the e-mail group is used as a recipient of an e-mail, the e-mail is sent to each e-mail address in the e-mail group respectively.

An apparatus for creating an e-mail group is also provided, which includes:

a detection unit that detects an e-mail group creating demand for an instant messaging group;

an extraction unit that extracts an e-mail address corresponding to each member according to members contained in the instant messaging group; and a generation unit that collects the e-mail addresses corresponding to all of the members in the instant messaging group, and generates a corresponding e-mail group. When the e-mail group is used as a recipient of an e-mail, the e-mail is sent to each e-mail address in the e-mail group respectively.

As shown from the above technical solutions, the present disclosure, by detecting an e-mail group creating demand, intelligently detects a user demand. Thus, the present disclosure meets the user demand by automatically creating an e-mail group and also reduces the pressure on the server by controlling the generation time of the group. At the same time, an e-mail account that is generated for generating an e-mail group may be an e-mail address bound with each member, and there is no limit to the type of the e-mail address, which is in line with a user's daily use habit.

### BRIEF DESCRIPTION OF THE DRAWINGS

In order to clearly describe the technical solutions in the example embodiments of the present disclosure, the accompanying drawings are used to aid in describing the example embodiments. Apparently, the accompanying drawings in the following description merely represent some example embodiments of the present disclosure; persons of ordinary skill in the art may obtain other drawings according to the accompanying drawings without using creative efforts.

FIG. 1 is a schematic flowchart of an example e-mail processing method according to one example embodiment of the present disclosure;

FIG. 2 is a schematic structural diagram of an example e-mail processing apparatus according to one example embodiment of the present disclosure;

FIG. 3 is a schematic structural diagram of an example e-mail processing apparatus according to another example embodiment of the present disclosure;

FIG. 4 is a schematic structural diagram of an example e-mail processing apparatus according to another example embodiment of the present disclosure;

FIG. 5 is a schematic structural diagram of an example e-mail processing apparatus according to another example embodiment of the present disclosure;

FIG. 6 is a schematic structural diagram of an example e-mail processing system according to one example embodiment of the present disclosure;

FIG. 7 is a schematic diagram of an application scenario according to an example embodiment of the present disclosure;

FIG. 8 is a flow chart of an example method for creating an e-mail group according to an example embodiment of the present disclosure;

FIG. 9 is a schematic diagram of an example organizational structure inside an enterprise according to an example embodiment of the present disclosure;

FIGS. 10-13 are schematic interface diagrams of an example process of creating an e-mail group according to an example embodiment of the present disclosure;

FIG. 14 is a schematic diagram of updating of an e-mail group according to an example embodiment of the present disclosure;

FIG. 15 is a schematic structural diagram of an example electronic device according to an example embodiment of the present disclosure; and

FIG. 16 is a block diagram of an example apparatus for creating an e-mail group according to an example embodiment of the present disclosure.

### DETAILED DESCRIPTION

In order to make the objectives, technical solutions and advantages of the example embodiments of the present disclosure clear, the technical solutions of the present disclosure will be described below with reference to the accompanying drawings in the example embodiments of the present disclosure. It is apparent that the example embodiments merely represent a part and not all of the example embodiments of the present disclosure. All other example embodiments derived by persons of ordinary skill in the art based on the example embodiments of the present disclosure without using creative efforts should fall within the protection scope of the present disclosure.

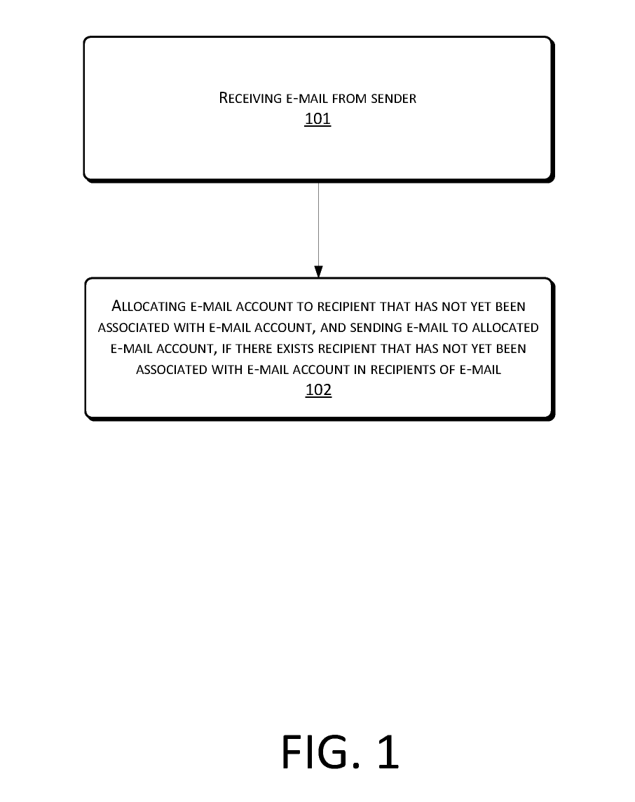

FIG. 1 is a schematic flowchart of an e-mail processing method according to an example embodiment of the present disclosure. As shown in FIG. 1, the method includes:

101, a server receives an e-mail from a sender.

102, if there exists a recipient that has not yet been associated with an e-mail account in the recipients of the e-mail, the server allocates an e-mail account to the recipient that has not yet been associated with an e-mail account, and sends the e-mail to the allocated e-mail account.

In conventional techniques, if an IM user hopes to receive a mail through an IM client terminal, it is necessary to associate the IM client terminal with a specified e-mail account in advance. If the IM user has not been associated with an e-mail account, it cannot receive e-mails sent by other users, which may affect communication efficiency between users. With respect to the problem, in this example embodiment, an e-mail processing method is provided, which may be performed by a server in an e-mail processing system, to solve the problem that an e-mail cannot be received.

For example, when needing to send an e-mail to a recipient, a sender generates the e-mail through a client terminal thereof, and then sends the e-mail to a server through the client terminal, to forward the e-mail to the recipient through the server. The server receives the e-mail from the sender. Reference may be made to the conventional techniques for the process of transmitting an e-mail between a client terminal of a sender and a server, which is not described with more details herein.

It should be noted that this example embodiment does not limit the type of a client terminal used by a sender, which may be any client terminal having an e-mail function, for example, a NeteaseTM mailbox client terminal, a YahooTM mailbox client terminal, outlook, or an IM tool having an e-mail function or the like. The IM tool having an e-mail function may be an IM tool with a built-in e-mail function, and may also be an IM tool that may call an e-mail application to implement an e-mail function. For example, an IM tool having an e-mail function is Dingtalk.

In this example embodiment, it is required that the recipient be associated with an e-mail account, and the server needs to forward an e-mail based on the e-mail account with which the recipient is associated. Otherwise, the recipient cannot receive the e-mail sent by the sender. That the recipient is associated with an e-mail account refers to that the recipient associates a client terminal thereof used for conducting communication with the server with at least one specified e-mail account.

Based on the above, after receiving the e-mail of the sender, the server determines whether or not there exists a recipient that has not yet been associated with an e-mail account in the recipients of the e-mail. For example, it is feasible to generate an association list in advance, the association list storing IDs of associated users and e-mail accounts with which the associated users are associated. Thus, the server may match an ID of a recipient of the e-mail in the association list. If an ID of an associated user the same as the ID of the recipient of the e-mail is matched in the association list, the server determines that the recipient of the e-mail has already been associated with an e-mail account, and further acquires an e-mail account corresponding to the ID of the associated user matched as the e-mail account that the recipient has been associated with. If no ID of an associated user that is the same as the ID of the recipient of the e-mail is matched in the association list, the server determines that the recipient of the e-mail has not yet been associated with an e-mail account.

If it is determined that there exists a recipient that has not yet been associated with an e-mail account in the recipients of the e-mail, with respect to the recipient that has not yet been associated with an e-mail account, the server temporarily allocates an e-mail account to the recipient that has not yet been associated with an e-mail account, and sends the e-mail to the allocated e-mail account, thereby ensuring that the recipient that has not yet been associated with an e-mail account may successfully receive the e-mail, which enables information of the sender to be successfully transmitted to the recipient and improves communication efficiency between the recipient and the sender.

It is worth noting that, when allocating an e-mail account to the recipient that has not yet been associated with an e-mail account, the server needs to generate an e-mail account name used by the e-mail account. For example, the server may generate a random e-mail account name based on a random algorithm. For instance, it is feasible to generate the e-mail account name according to a mobile phone number, a nickname and the like of the recipient, and the e-mail account name may be a combination of various available symbols such as letters, numbers and hyphens. For example, an e-mail account name allocated to the recipient “Chen Gang” may be vpvjb5s.

Further, if it is determined that there exists a recipient that has already been associated with an e-mail account in the recipients of the e-mail, with respect to the recipient that has already been associated with an e-mail account, the server directly sends the e-mail to the e-mail account with which the recipient that has already been associated with an e-mail account is associated.

It is worth noting that the recipient that has not yet been associated with an e-mail account refers to a recipient that has not yet associated a client terminal thereof used for conducting communication with the server with a specified e-mail account. For such a recipient, the server cannot forward an e-mail thereto. The recipient that has already been associated with an e-mail account refers to a recipient that has already associated a client terminal thereof used for conducting communication with the server with a specified e-mail account. For such a recipient, the server forwards an e-mail to the e-mail account with which the recipient is associated.

Likewise, this example embodiment does not limit the type of a client terminal used by a recipient, which may be any client terminal that conducts communication with a server and is bound with an e-mail account. For example, the client terminal may be various IM tools such as Dingtalk, QQ and WeChat.

In an application scenario, the client terminal of the recipient is an IM client terminal, and the server is an IM server. Correspondingly, the client terminal of the sender may also be an IM client terminal. For the convenience of distinction and description, the IM client terminal of the sender is referred to as a sending-end IM client terminal, and the IM client terminal of the recipient is referred to as a receiving-end IM client terminal. It is worth noting that, when the client terminal of the recipient is an IM client terminal, it is not required that the client terminal of the sender must be an IM client terminal. However, the client terminals of the recipient and the sender are both IM client terminals, and moreover, are the IM client terminals of the same system is an application scheme more common and easy to deploy and implement. For example, in specific implementation, the recipient uses a Dingtalk client terminal, the sender uses a Dingtalk client terminal, and the server is a Dingtalk server, or the recipient uses a WeChatTM client terminal, the sender uses a WeChat client terminal, and the server is a WeChat server, or the recipient uses a QQ client terminal, the sender uses a QQ client terminal, and the server is a QQ server, and so on.

In the following example embodiment, description is provided by using the client terminal of the recipient as an IM client terminal as an example. In the following description, the receiving-end IM client terminal, for example, refers to an IM client terminal of the recipient that has not yet been associated with an e-mail account in the recipients of the e-mail.

In the case that the client terminal of the recipient is an IM client terminal, the server receives an e-mail from the sender. With respect to the recipient that has not yet been associated with an e-mail account in the recipients of the e-mail, the server allocates an e-mail account to the recipient that has not yet been associated with an e-mail account, and sends the e-mail to the allocated e-mail account. Afterwards, the server sends a mail notification message to a receiving-end IM client terminal, to notify the recipient that has not yet been associated with an e-mail account to view the e-mail. It is worth noting that a communication way between the server and the receiving-end IM client terminal is an IM way.

Likewise, with respect to the recipient that has already been associated with an e-mail account in the recipients of the e-mail, the server sends the e-mail to the e-mail account that has already been associated with the recipient. Afterwards, the server sends a mail notification message to an IM client terminal of the recipient that has already been associated with an e-mail account, to notify the recipient that has already been associated with an e-mail account to view the e-mail.

With respect to the receiving-end IM client terminal, it is not necessary to distinguish whether or not the recipient has already been associated with an e-mail account. After receiving the mail notification message sent by the server, the receiving-end IM client terminal logs into the corresponding e-mail account to acquire the e-mail according to the mail notification message. With respect to the recipient that has not yet been associated with an e-mail account, the receiving-end IM client terminal needs to log into the e-mail account allocated by the server thereto, to acquire the e-mail. With respect to the recipient that has already been associated with an e-mail account, the receiving-end IM client terminal needs to log into the e-mail account with which the recipient has already been associated, to acquire the e-mail.

Optionally, after receiving the mail notification message sent by the server, the receiving-end IM client terminal may display the mail notification message to the recipient (herein, the recipient includes the recipient that has already been associated with an e-mail account and the recipient that has not yet been associated with an e-mail account) in the form of a message flow in a message flow list of a main page thereof, to notify the recipient that there is an e-mail to be read. In the implementation mode, after receiving an instruction of the recipient, the receiving-end IM client terminal logs into the corresponding e-mail account according to the mail notification message, to acquire the e-mail. It is worth noting that the message low list of this example embodiment may display messages in various forms, including free business calls, call records, e-mail receiving and sending notification messages, approval task notification and so on.

It is worth noting that, with respect to the recipient that has not yet been associated with an e-mail account, one situation is that it is likely that the recipient has registered an IM account and installed an IM client terminal, but has not yet been associated with an e-mail account; and the other situation is that the recipient has not yet registered an IM account and has not been associated with an e-mail account.

For the latter, the server further needs to send a registration notification message to the recipient that has not yet been associated with an e-mail account in a communication manner different from the receiving-end IM client terminal, to notify the recipient that has not yet been associated with an e-mail account to register an IM account. With respect to the recipient that has not yet been associated with an e-mail account and has not yet registered an IM account, according to the registration notification message, a registration request is sent to the server through a receiving-end IM client terminal thereof, and an IM account desired for registration is carried in the registration request. The server receives the registration request sent by the receiving-end IM client terminal. The server returns a registration success response to the receiving-end IM client terminal.

The communication manner different from the receiving-end IM client terminal may be another IM communication manner or a non-IM communication manner different from the receiving-end IM client terminal. For example, suppose that the receiving-end IM client terminal is a Dingtalk client terminal, another IM communication manner different from the receiving-end IM client terminal may be WeChatTM, QQ or other communication manners; the non-IM communication manner different from the receiving-end IM client terminal may be short message, telephone or other communication manners.

With respect to the recipient that has not yet been associated with an e-mail account and has not yet registered an IM account, if an IM client terminal has not yet been installed, it is feasible to first download and install the IM client terminal and then register at the server.

Optionally, in order to make the recipient more easily download and install the IM client terminal, the registration notification message sent by the server may include a download address of the IM client terminal for the recipient that has not yet been associated with an e-mail account (the recipient that has not yet been associated with an e-mail account and has not yet registered an IM account) to download and install the IM client terminal. The IM client terminal after being installed is the receiving-end IM client terminal.

Further, after receiving a registration request from the recipient that has not yet been associated with an e-mail account and has not yet registered an IM account, the server obtains the IM account of the recipient and then establishes an association relationship between the IM account of the recipient that has not yet been associated with an e-mail account and the allocated e-mail account.

Further, in the method according to this example embodiment, after allocating an e-mail account to the recipient that has not yet been associated with an e-mail account, the server allows the recipient to make modification, to adapt to users' application demands.

Based on the above, the server receives an e-mail account modification request sent by the receiving-end IM client terminal; and modifies the allocated e-mail account according to the e-mail account modification request.

One specific modification manner is as follows: the recipient modifies the name of the e-mail account. Thus, the server, for example, modifies the name of the allocated e-mail account according to the e-mail account modification request. Optionally, the e-mail account modification request includes a target e-mail account name that the name of the e-mail account is to be modified.

Another specific modification manner is as follows: the recipient hopes to replace the e-mail account allocated by the server with another e-mail account. Thus, the server, for example, modifies the allocated e-mail account to another e-mail account according to the e-mail account modification request. Optionally, the e-mail account modification request may include a target e-mail account that the e-mail account is to be modified.

In an optional implementation mode, the client terminal used by the sender is also an IM client terminal, that is, the sending-end IM client terminal. In the implementation mode, the server receives an e-mail sent by the sending-end IM client terminal.

Before sending the e-mail to the server, the sending-end IM client terminal needs to generate the e-mail. The process that the sending-end IM client terminal generates the e-mail includes:

acquiring, by the sending-end IM client terminal, content of the e-mail, and determining a recipient of the e-mail; and

generating, by the sending-end IM client terminal, the e-mail according to the content of the e-mail and the recipient of the e-mail.

The manner in which the sending-end IM client terminal acquires content of the e-mail includes, but is not limited to, the following:

acquiring the content of the e-mail from a specified storage space;

acquiring content of previous e-mails; and

receiving content of the e-mail input by the sender.

The implementation mode of receiving content of the e-mail input by a user is as follows:

The sending-end IM client terminal acquires a mail writing instruction of the sender; for example, the sending-end IM client terminal displays a main interface of the sending-end IM client terminal. The main interface of the sending-end IM client terminal includes a mail icon or a mail message entry. Optionally, the mail icon may be a “+” icon at the lower right corner of the main interface. The sender, by operating the mail icon or the mail message entry in a clicking or double-clicking manner, sends a mail writing instruction, and then enters a mail writing interface. The sending-end IM client terminal receives the mail writing instruction sent out by the sender through the mail icon or the mail message entry.

Afterwards, the sending-end IM client terminal displays the mail writing interface according to the mail writing instruction; and the recipient may input content of the e-mail on the mail writing interface. The sending-end IM client terminal acquires content of the e-mail input by the sender on the mail writing interface.

Optionally, the mail writing interface further includes a recipient list.

The manner in which the sending-end IM client terminal determines a recipient of the e-mail is to receive a recipient selected and added by the sender.

The recipient that may be selected and added by the sender may be a contact in an enterprise address book. For example, if an enterprise where the user works is Alibaba™ the user may select and add contacts under the organization structure of Alibaba™, and also quickly add contacts of the department where the user belongs, such as colleagues under the Intellectual Property Department.

In addition to adding the contacts in the enterprise address book, the sender may further add contacts in a mobile phone address book, or the sender may also directly add a contact that neither has registered an IM account nor has been associated with an e-mail account, and send a mail to the contact. For example, the contact added by the sender may only have a mobile phone number of a communication operator. For convenience of distinction, a contact that has registered an IM account may have an IM graphic marker on the right of contact information thereof, which, for example, may be, but not limited to, a white head portrait on a green background. For a contact that has not registered an IM account, no IM graphic marker will be present in contact information thereof

After adding of the recipients is completed, abbreviated names, nicknames, mobile phone numbers or e-mails and other ID information of the contacts will be present in the recipient list of the mail writing interface.

Certainly, such mail sending manner is also applicable to contacts of carbon copy and blind carbon copy.

In the conventional techniques, when adding the recipients, the sender generally adds the recipients one by one; in an actual application, it is common to encounter a situation of group sending. At this point, if the recipients are added one by one, the efficiency may be lower. With respect to the problem, in this example embodiment, a recipient adding manner is provided, which for example includes:

displaying, by the sending-end IM client terminal, at least one contact group, each contact group including at least one contact;

receiving, by the sending-end IM client terminal, a selecting instruction sent by the sender, the selecting instruction being used for selecting a target contact group from the at least one contact group; and

using, by the sending-end IM client terminal, a contact in the target contact group as the recipient of the e-mail, and adding the contact to a recipient list of the e-mail.

Optionally, for the target contact group selected by the sender, the sender may select all or some of the contacts in the group as recipients.

Based on the group adding manner according to this example embodiment, the sender may select a business group to which the sender belongs, or may also select a group matched with a mail sending subj ect thereof to add the recipients, instead of adding the recipients one by one, thereby greatly improving the efficiency of adding the recipients and then improving the efficiency of generating an e-mail.

In an optional implementation mode, the sending-end IM client terminal may sort the at least one contact group according to correlation between the at least one contact group and the content of the e-mail. In this way, it is feasible to push a contact group having higher correlation with the content of the e-mail to the front, which is convenient for the sender to select preferentially. In specific implementation, the sending-end IM client terminal may determine contacts according to content of a current e-mail. For example, if the sender is a product manager and is writing an e-mail about a product function requirement, the sending-end IM client terminal may determine correlation between contact groups and the content of the e-mail through keywords or position attributes of contacts and the like.

Alternatively, the sending-end IM client terminal may sort the at least one contact group according to a historical selection probability of the sender for the at least one contact group. In this way, it is feasible to push a contact group usually selected by the sender to the front, which is convenient for the sender to select preferentially. In specific implementation, the sending-end IM client terminal may make statistics on selection probabilities of the sender for respective contact groups in a past period of time, and sort the respective contact groups based on the historical selection probabilities.

In an optional implementation mode, before using the at least one contact group, the sending-end IM client terminal also needs to divide contacts of the sender into at least one contact group. For example, the sending-end IM client terminal may divide contacts of the sender into at least one contact group according to recipient information of historical e-mails of the sender. The historical e-mails of the sender refer to e-mails sent by the sender before the contact group is formed. When the sender sends the historical e-mails, it is feasible to add the recipients one by one according to the conventional techniques. In general, for e-mails having different subjects or content, their recipients may be different, while for e-mails having the same or similar subjects or content, their recipients may generally be the same; therefore, the sending-end IM client terminal may determine similarity between contacts of the sender through conducting statistics and analysis on recipient information of historical e-mails of the sender, and then divide the contacts of the sender into different contact groups.

It is worth noting that information of the at least one contact group may be maintained by the sending-end IM client terminal alone, and in this way, the sending-end IM client terminal may locally acquire contact groups, which help to improve acquisition efficiency.

In another optional implementation mode, the sending-end IM client terminal sends a group acquisition request to the server; and the sending-end IM client terminal receives at least one contact group returned by the server. In the implementation manner, information of the at least one contact group is maintained by the server in a unified way, which facilitates maintenance and management, and further reduces the load of the sending-end IM client terminal.

In the implementation mode that the server maintains the contact group in a unified way, before returning at least one contact group to the sending-end IM client terminal, the server may sort the at least one contact group and return the sorted contact group to the sending-end IM client terminal.

A sorting manner is as follows: the server may sort the at least one contact group in advance according to correlation between the at least one contact group and the content of the e-mail; in this way, it is feasible to push a contact group having higher correlation with the content of the e-mail to the front, which is convenient for the sender to select preferentially. In specific implementation, the server may determine contacts be according to content of a current e-mail. For example, if the sender is a product manager and is writing an e-mail about a product function requirement, the server may determine correlation between contact groups and the content of the e-mail through keywords or position attributes of contacts and the like.

Another sorting manner is as follows: the server may sort the at least one contact group according to a historical selection probability of the sender for the at least one contact group. In this way, it is feasible to push a contact group usually selected by the sender to the front, which is convenient for the sender to select preferentially. In specific implementation, the server may make statistics on selection probabilities of the sender for respective contact groups in a past period of time, and sort the respective contact groups based on the historical selection probabilities.

In the implementation mode that the server maintains the contact group, before returning at least one contact group to the sending-end IM client terminal, the server also needs to divide contacts of the sender into at least one contact group. For example, the server may divide contacts of the sender into at least one contact group according to recipient information of historical e-mails of the sender. The historical e-mails of the sender refer to e-mails sent by the sender before the contact group is formed. When the sender sends the historical e-mails, it is feasible to add the recipients one by one according to the conventional techniques. In general, for e-mails having different subjects or content, their recipients may be different, while for e-mails having the same or similar subjects or content, their recipients may generally be the same; therefore, the server may determine similarity between contacts of the sender through conducting statistics and analysis on recipient information of historical e-mails of the sender, and then divide the contacts of the sender into different contact groups.

Further, after adding the recipients, the sender may also delete the recipients, in order to finally determine the recipients of the e-mail. For example, the sender may send out a deleting instruction; the sending-end IM client terminal receives the deleting instruction of the sender; and the sending-end IM client terminal deletes a recipient corresponding to the deleting instruction from the recipient list.

In an implementation mode, the sender may directly operate an ID of a recipient in the recipient list to send out a deleting instruction. For example, the sender may click or double-click an ID of the recipient to send out a deleting instruction, or right-click the ID of the recipient to call a deleting option and send out a deleting instruction by clicking the deleting option. The sending-end IM client terminal receives the deleting instruction sent out by the sender by operating an ID of a recipient of the e-mail in the recipient list.

In another implementation mode, when adding the recipient of the e-mail to the recipient list, the sending-end IM client terminal displays a deleting button corresponding to the recipient of the e-mail in the recipient list. Thus, the sender may operate a deleting button corresponding to the recipient of the e-mail in the recipient list to send out a deleting instruction. For example, it is feasible to click a deleting button to send out a deleting instruction. The sending-end IM client terminal receives the deleting instruction sent out by the sender by operating a deleting button corresponding to the recipient of the e-mail in the recipient list.

After determining the recipient of the e-mail and acquiring the content of the e-mail, the receiving-end IM client terminal generates the e-mail; and then sends the e-mail to the server, for the server to perform the above operations to process the e-mail.

In view of the above, in the present disclosure, the server allocates an e-mail account to the recipient that has not yet been associated with an e-mail account, and sends the e-mail to the allocated e-mail account, thereby ensuring that the recipient successfully receives the e-mail of the sender, which solves the problem that an e-mail cannot be received and improves communication efficiency between users.

It should be noted that, for the convenience of brevity, the method example embodiments are all expressed as a series of action combinations; however, persons skilled in the art should know that the present disclosure is not limited by the order of the actions described, because some steps may be performed in another order or at the same time according to the present disclosure. Secondly, persons skilled in the art should also know that the example embodiments described in the specification are examples, and the actions and modules involved are not necessary for the present disclosure.

In the above example embodiments, the description of each example embodiment has its own focus; for the content that is not detailed in a certain example embodiment, reference may be made to the relevant description of another example embodiment.

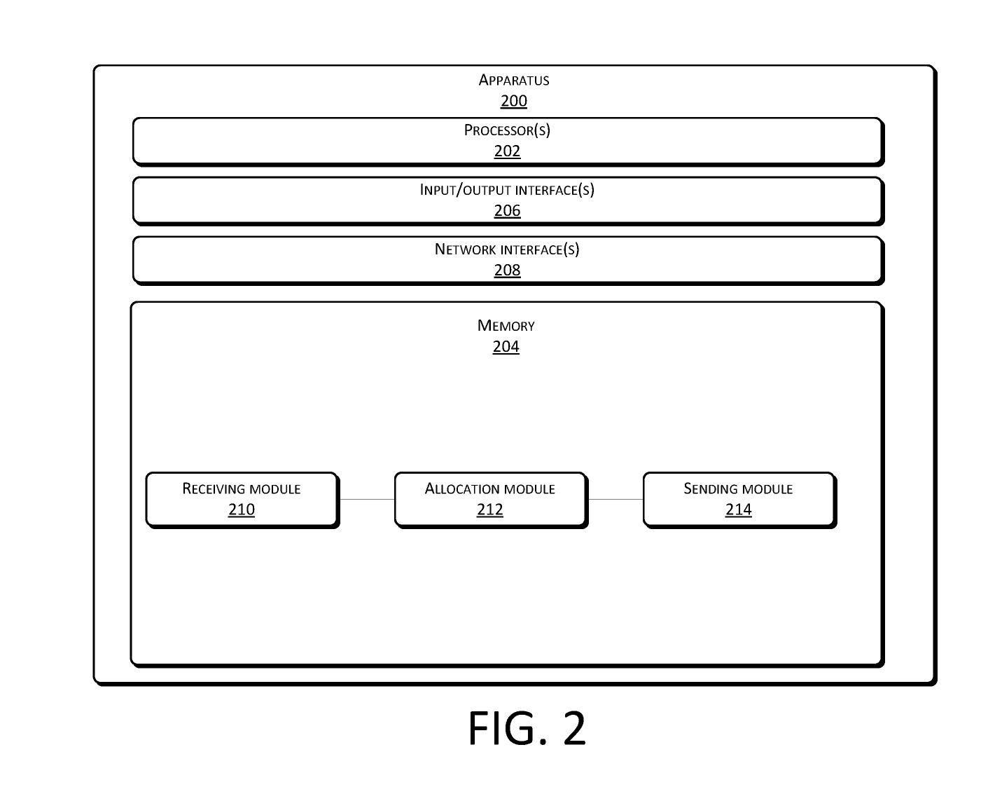

FIG. 2 is a schematic structural diagram of an e-mail processing apparatus 200 according to one example embodiment of the present disclosure. The apparatus 200 may be implemented in a server. As shown in FIG. 2, the apparatus 200 includes one or more processor(s) 202 or data processing unit(s) and memory 204. The apparatus 200 may further include one or more input/output interface(s) 206, and network interface(s) 208. The memory 204 is an example of computer readable media.

The memory 204 may store therein a plurality of modules or units including a receiving module 210, an allocation module 212 and a sending module 214.

The receiving module 210 receives an e-mail from a sender.

The allocation module 212, in response to determining that there exists a recipient that has not yet been associated with an e-mail account in the recipients of the e-mail received by the receiving module 210, allocates an e-mail account to the recipient that has not yet been associated with an e-mail account.

The sending module 214 sends the e-mail received by the receiving module 210 to the e-mail account allocated by the allocation module 212.

In an optional implementation mode, the sending module 214 further, in response to determining that there exists a recipient that has already been associated with an e-mail account in the recipients of the e-mail, sends the e-mail to the e-mail account with which the recipient that has already been associated with an e-mail account is associated.

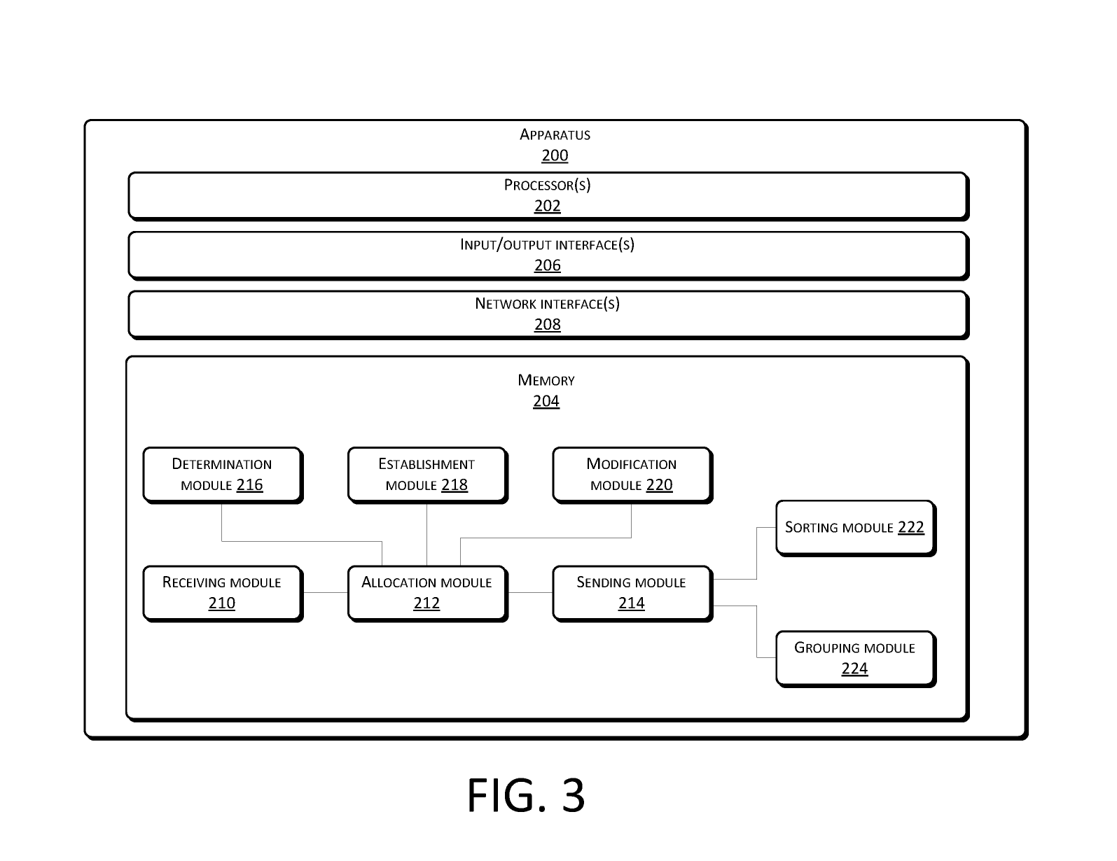

In an optional implementation mode, as shown in FIG. 3, the apparatus 200 further includes a determination module 216 stored in memory 204.

The determination module 216 matches an ID of a recipient of the e-mail to IDs in an association list. If an ID of an associated user that is the same as the ID of the recipient of the e-mail is matched in the association list, the determination module 216 determines that the recipient of the e-mail has already been associated with an e-mail account. If no ID of an associated user that is the same as the ID of the recipient of the e-mail is matched in the association list, the determination module 216 determines that the recipient of the e-mail has not yet been associated with an e-mail account. The association list stores IDs of associated users and e-mail accounts with which the associated users are associated. The determination module 216 provides a determining result for the allocation module 212.

In an optional implementation mode, the sending module 214 further sends a mail notification message to a receiving-end IM client terminal, to notify the recipient that has not yet been associated with an e-mail account to view the e-mail, the receiving-end IM client terminal being an IM client terminal of the recipient that has not yet been associated with an e-mail account.

In an optional implementation mode, the sending module 214 further sends a registration notification message to the recipient that has not yet been associated with an e-mail account in a communication manner different from the receiving-end IM client terminal, to notify the recipient that has not yet been associated with an e-mail account to register an IM account. Correspondingly, the receiving module 210 further receives a registration request sent by the receiving-end IM client terminal, the registration request including the IM account of the recipient that has not yet been associated with an e-mail account. The sending module 214 further returns a registration success response to the receiving-end IM client terminal.

In an optional implementation mode, the registration notification message includes: a download address of an IM client terminal for the recipient that has not yet been associated with an e-mail account to download and install the receiving-end IM client terminal.

In an optional implementation mode, as shown in FIG. 3, the apparatus 200 further includes an establishment module 218 stored in memory 204.

The establishment module 218 establishes an association relationship between the IM account of the recipient that has not yet been associated with an e-mail account and the e-mail account allocated by the allocation module 212.

In an optional implementation mode, as shown in FIG. 3, the apparatus 200 further includes a modification module 220 stored in memory 204.

The receiving module 210 further receives an e-mail account modification request sent by the receiving-end IM client terminal. Correspondingly, the modification module 220 modifies the allocated e-mail account according to the e-mail account modification request received by the receiving module 210.

Optionally, the modification module 220 may, for example, perform the following operations:

modifying the name of the allocated e-mail account according to the e-mail account modification request; or

modifying the allocated e-mail account to another e-mail account according to the e-mail account modification request.

In an optional implementation mode, the receiving module 210 may, for example, perform receiving the e-mail sent by a sending-end IM client terminal, the sending-end IM client terminal being an IM client terminal of the sender.

Based on the above, the receiving module 210 further receives a group acquisition request sent by a sending-end IM client terminal. The sending module 214 further returns at least one contact group to the sending-end IM client terminal so that the sending-end IM client terminal selects a recipient to be added therefrom.

Optionally, as shown in FIG. 3, the apparatus further includes a sorting module 222 stored in memory 204.

The sorting module 222, before the sending module 214 returns at least one contact group to the sending-end IM client terminal, sorts the at least one contact group according to correlation between the at least one contact group and the content of the e-mail.

Alternatively, the sorting module 222, before the sending module 214 returns at least one contact group to the sending-end IM client terminal, sorts the at least one contact group according to a historical selection probability of the sender for the at least one contact group.

Optionally, as shown in FIG. 3, the apparatus further includes: a grouping module 224.

The grouping module 224, before the sending module 214 returns at least one contact group to the sending-end IM client terminal, divides contacts of the recipient into the at least one contact group according to recipient information of historical e-mails of the sender.

The e-mail processing apparatus, according to this example embodiment, receives an e-mail from a sender. If there exists a recipient that has not yet been associated with an e-mail account in the recipients of the e-mail, the e-mail processing apparatus allocates an e-mail account to the recipient that has not yet been associated with an e-mail account, and sends the e-mail to the allocated e-mail account, thereby ensuring that a recipient successfully receives an e-mail of a sender, which solves the problem that an e-mail cannot be received and improves communication efficiency between users.

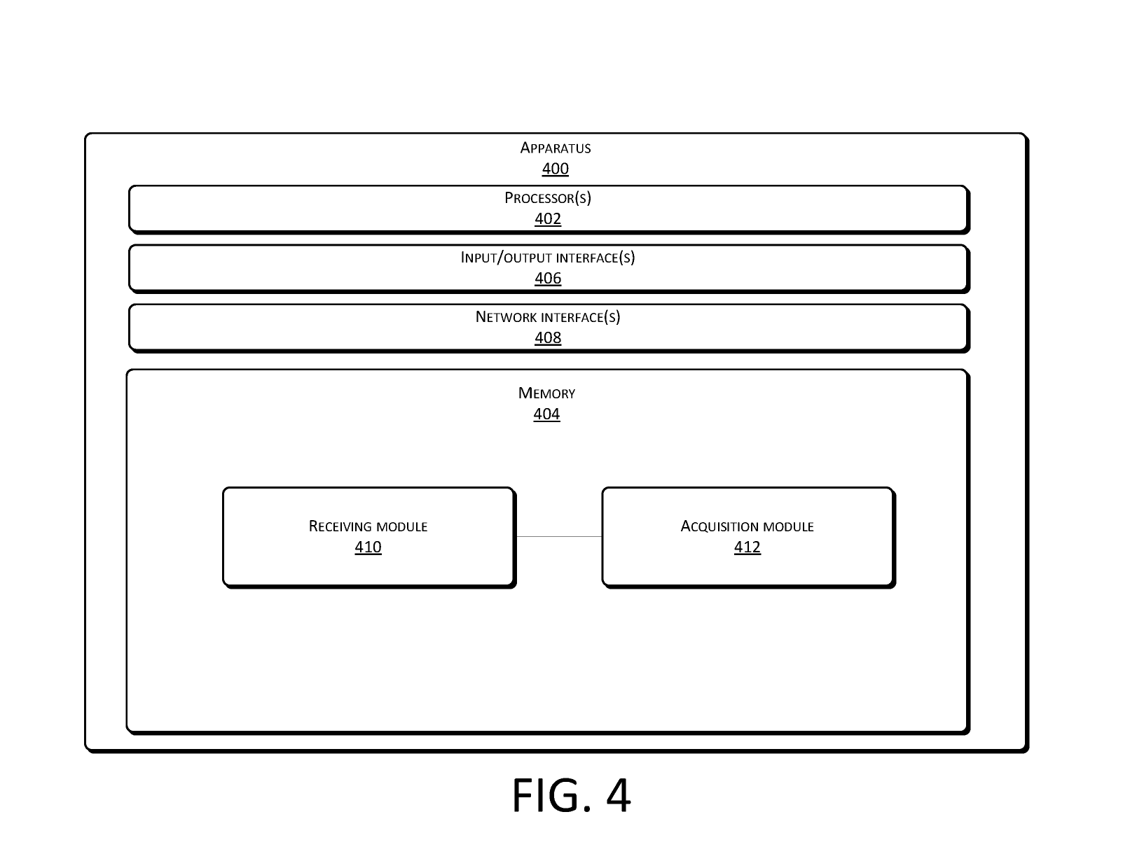

FIG. 4 is a schematic structural diagram of an e-mail processing apparatus 400 according to a further example embodiment of the present disclosure. The apparatus 400 is located in a receiving-end IM client terminal, the receiving-end IM client terminal being an IM client terminal of a recipient. As shown in FIG. 4, the apparatus 400 includes one or more processor(s) 402 or data processing unit(s) and memory 404. The apparatus 400 may further include one or more input/output interface(s) 406, and network interface(s) 408. The memory 404 is an example of computer readable media.

The memory 404 may store therein a plurality of modules or units including a receiving module 410 and an acquisition module 412.

The receiving module 410 receives a mail notification message sent by a server.

The acquisition module 412 logs into an e-mail account where the e-mail is stored according to the mail notification message received by the receiving module 410 to acquire the e-mail. The e-mail account is temporarily allocated by the server to the recipient.

Optionally, the apparatus 400 may further include a display module (not shown in FIG. 4) stored in memory 404 that displays the mail notification message on a main interface of the apparatus in the form of information flow for the recipient to be informed that there is an e-mail to be read.

Further optionally, the apparatus 400 further include a sending module and a generation module (both not shown in FIG. 4) stored in memory 404.

The generation module acquires a modified target e-mail account name or target e-mail account input by the recipient, and generates the e-mail account modification request according to the target e-mail account name or target e-mail account.

The sending module sends the e-mail account modification request generated by the generation module to the server, to make the server modify the e-mail account.

It is worth noting that the e-mail processing apparatus of this example embodiment, in addition to having the function described in this example embodiment, further has some conventional functions that a receiving-end IM client terminal should have, which are not described herein for brevity.

The e-mail processing apparatus according to this example embodiment is implemented in a receiving-end IM client terminal, and cooperates with a server, so that a recipient may successfully receive an e-mail sent by a sender in the case that the recipient has not yet been associated with an e-mail account, which helps to improve success probability of information transmission, and improves communication efficiency between a sender and a recipient.

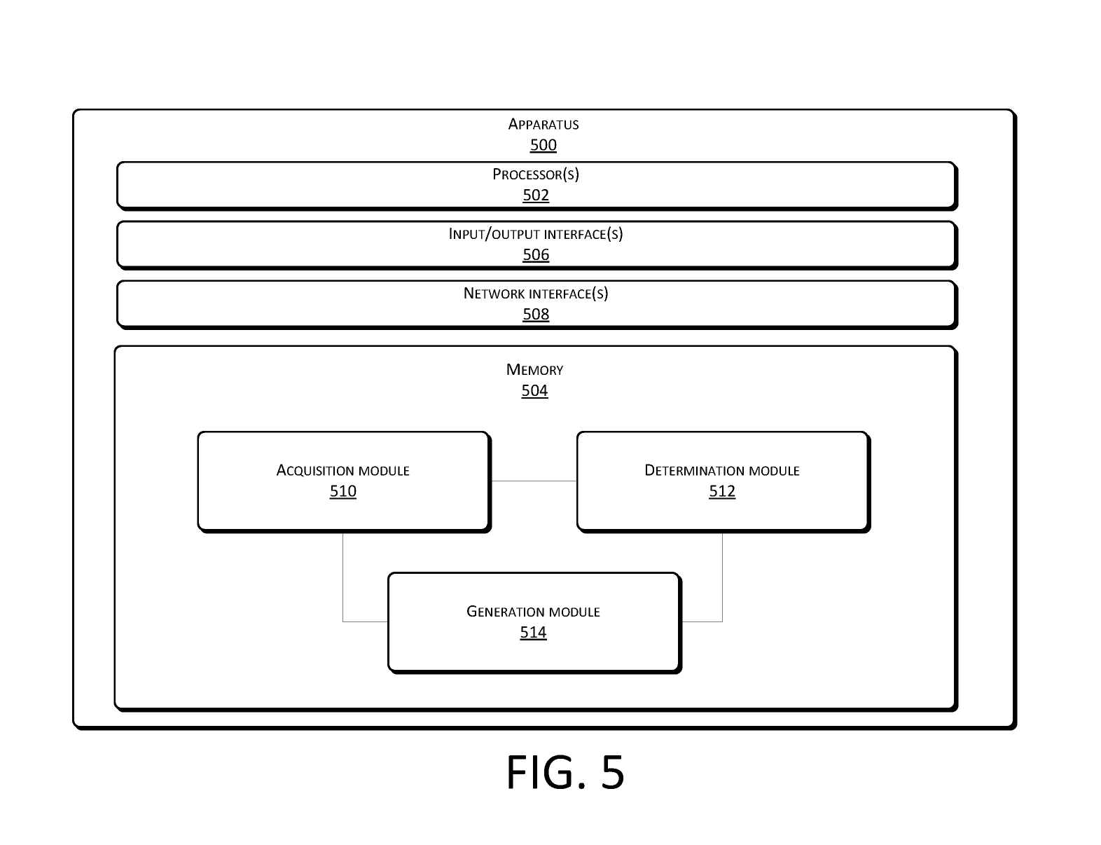

FIG. 5 is a schematic structural diagram of an e-mail processing apparatus 500 according to a further example embodiment of the present disclosure. The apparatus 500 is implemented in a sending-end IM client terminal, the sending-end IM client terminal being an IM client terminal of a sender. As shown in FIG. 5, the apparatus 500 includes one or more processor(s) 502 or data processing unit(s) and memory 504. The apparatus 500 may further include one or more input/output interface(s) 506, and network interface(s) 508. The memory 504 is an example of computer readable media.

The memory 504 may store therein a plurality of modules or units including an acquisition module 510, a determination module 512 and a generation module 514.

The acquisition module 510 acquires content of an e-mail.

The determination module 512 determines a recipient of the e-mail. The recipient of the e-mail is determined in a manner of a contact group.

The generation module 514 generates the e-mail according to the content of the e-mail received by the acquisition module 510 and the recipient of the e-mail determined by the determination module 512.

In an optional implementation mode, the determination module 512 may, for example, perform the following operations:

displaying at least one contact group;

receiving a selecting instruction sent by the sender, the selecting instruction being used for selecting a target contact group from the at least one contact group; and

using a contact in the target contact group as the recipient of the e-mail, and adding the contact to a recipient list of the e-mail.

In an optional implementation mode, the determination module 512 further displays a deleting button corresponding to the recipient of the e-mail in the recipient list, for the sender to adjust the recipient. For example, it is feasible to delete an undesired recipient through the deleting button.

In an optional implementation mode, the apparatus 500 further includes a sorting module (not shown in FIG. 5) stored in memory 504.

The sorting module, before the determination module 512 displays at least one contact group, sorts the at least one contact group according to correlation between the at least one contact group and the content of the e-mail; or, before the determination module 512 displays at least one contact group, sorts the at least one contact group according to a historical selection probability of the sender for the at least one contact group. The sorting module provides the at least one contact group sorted for the determination module 512.

In an optional implementation mode, the apparatus 500 further includes a grouping module (not shown in FIG. 5) stored in memory 504.

The grouping module, before the determination module 512 displays at least one contact group, divides contacts of the recipient into the at least one contact group according to recipient information of historical e-mails of the sender.

It is worth noting that the e-mail processing apparatus of this example embodiment, in addition to having the functions described in this example embodiment, also has some conventional functions that a sending-end IM client terminal should have, which are not described herein for brevity.

The e-mail processing apparatus according to this example embodiment is implemented in a sending-end IM client terminal, and cooperates with a server, so that a recipient may successfully receive an e-mail sent by a sender in the case that the recipient has not yet been associated with an e-mail account, which helps to improve success probability of information transmission, and improves communication efficiency between a sender and a recipient. In addition, the e-mail processing apparatus, according to this example embodiment, allows the sender to add recipients in a group manner, which helps to improve the efficiency of adding recipients and then helps to improve the efficiency of generating an e-mail.

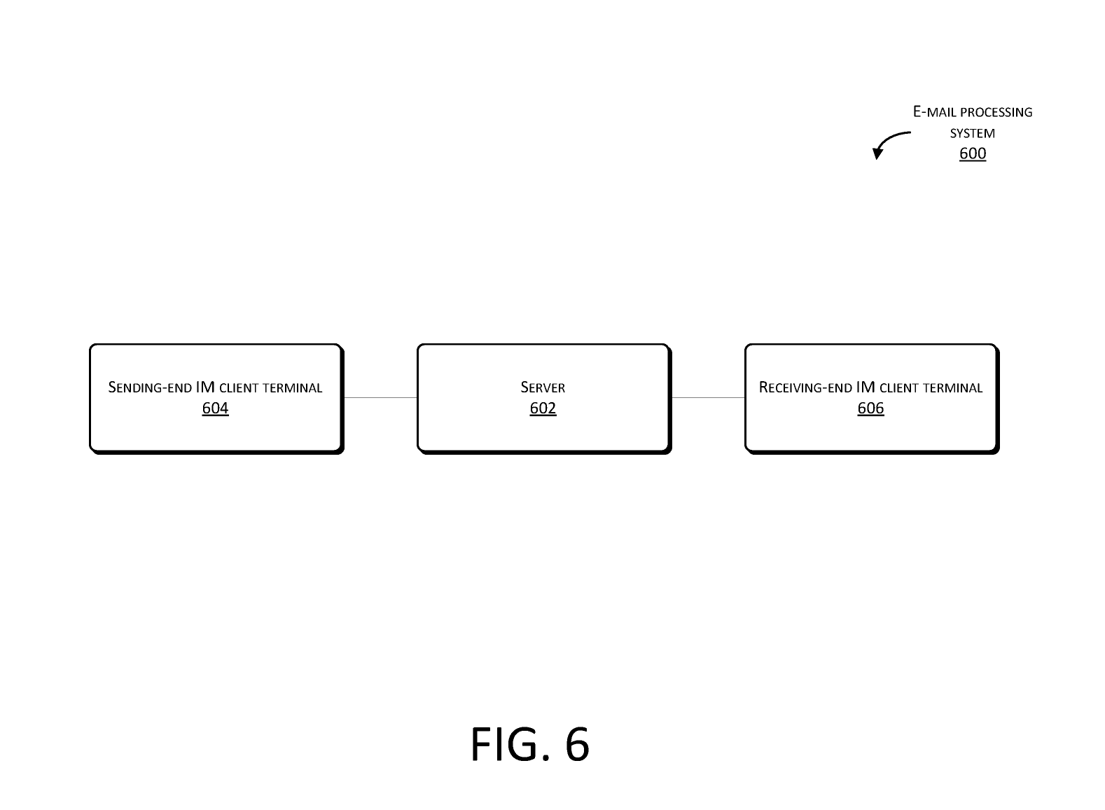

FIG. 6 is a schematic structural diagram of an e-mail processing system 600 according to one example embodiment of the present disclosure. As shown in FIG. 6, the e-mail processing system 600 includes: a server 602, a sending-end IM client terminal 604 and a receiving-end IM client terminal 606; the sending-end IM client terminal 604 is an IM client terminal of a sender; and the receiving-end IM client terminal 606 is an IM client terminal of a recipient.

The sending-end IM client terminal 604 generates an e-mail, and sends the e-mail to the server 602.

The server 602 receives the e-mail, and if there exists a recipient that has not yet been associated with an e-mail account in the recipients of the e-mail, allocates an e-mail account to the recipient that has not yet been associated with an e-mail account, sends the e-mail to the allocated e-mail account, and sends a mail notification message to the receiving-end IM client terminal 606.

The receiving-end IM client terminal 606 receives mail notification message sent by the server 602, and logs into the allocated e-mail account according to the mail notification message, to acquire the e-mail.

The sending-end IM client terminal 604, in the process of generating the e-mail, may, for example, perform the following operations:

acquiring content of the e-mail, and determining a recipient of the e-mail; and

generating the e-mail according to the content of the e-mail and the recipient of the e-mail.

The sending-end IM client terminal 604, when acquiring the content of the e-mail, may, for example, perform the following operations:

acquiring the content of the e-mail from a specified storage space;

acquiring content of previous e-mails; or

receiving content of the e-mail input by the sender.

The sending-end IM client terminal 604, when receiving the content of the e-mail input by a user, may, for example, perform the following operations:

acquiring a mail writing instruction of the sender;

displaying a mail writing interface according to the mail writing instruction so that the recipient may input the content of the e-mail on the mail writing interface; and

acquiring content of an e-mail input by the sender on the mail writing interface.

For example, the sending-end IM client terminal 604 displays a main interface of the sending-end IM client terminal 604, the main interface of the sending-end IM client terminal 604 including a mail icon or a mail message entry. Optionally, the mail icon may be a “+” icon at the lower right corner of the main interface; the sender, by operating the mail icon or the mail message entry in a clicking or double-clicking manner, sends out a mail writing instruction, and then enters a mail writing interface. The sending-end IM client terminal 604 receives the mail writing instruction sent out by the sender through the mail icon or the mail message entry.

Optionally, the mail writing interface further includes a recipient list.

The manner in which the sending-end IM client terminal 604 determines the recipient of the e-mail is receiving a recipient selected and added by the sender.

The recipient that may be selected and added by the sender may be a contact in an enterprise address book. For example, if an enterprise where the user works is Alibaba, the user may select and add contacts under the organization structure of Alibaba, and also quickly add contacts of the department where the user belongs, such as colleagues under the Intellectual Property Department.

In addition to adding the contacts in the enterprise address book, the sender may further add contacts in a mobile phone address book, or the sender may also directly add a contact which neither has registered an IM account nor has been associated with an e-mail account, and send a mail thereto. For example, the contact added by the sender may only have a mobile phone number of a communication operator. For convenience of distinction, a contact that has registered an IM account may have an IM graphic marker on the right of contact information thereof, which, for example, may be, but is not limited to, a white head portrait on a green background. With respect to a contact that has not registered an IM account, no IM graphic marker will be present in contact information thereof

After adding of the recipients is completed, abbreviated names, nicknames, mobile phone numbers or e-mails and other ID information of the contacts will be present in the recipient list of the mail writing interface.

Certainly, the above mail sending manner is also applicable to contacts of carbon copy and blind carbon copy.

In conventional techniques, when adding the recipients, the sender generally adds the recipients one by one; in an actual application, it is common to encounter a situation of group sending. At this point, if the recipients are added one by one, the efficiency may be lower. With respect to the problem, in this example embodiment, a recipient adding manner is provided, which for example includes:

displaying, by the sending-end IM client terminal 604, at least one contact group, each contact group including at least one contact;

receiving, by the sending-end IM client terminal 604, a selecting instruction sent by the sender, the selecting instruction being used for selecting a target contact group from the at least one contact group; and

using, by the sending-end IM client terminal 604, a contact in the target contact group as the recipient of the e-mail, and adding the contact to a recipient list of the e-mail.

Optionally, for the target contact group selected by the sender, the sender may select all or some of the contacts in the group as recipients.

Based on the group adding manner according to this example embodiment, the sender may select a business group to which the sender belongs, and may also select a group matched with a mail sending subject thereof, to add the recipients, instead of adding the recipients one by one, which greatly improves the efficiency of adding the recipients and then improves the efficiency of generating an e-mail.

In an optional implementation mode, the sending-end IM client terminal 604 may sort the at least one contact group according to correlation between the at least one contact group and the content of the e-mail. In this way, it is feasible to push a contact group having higher correlation with the content of the e-mail to the front, which is convenient for the sender to select preferentially. In specific implementation, the sending-end IM client terminal 604 may determine contacts according to content of a current e-mail. For example, if the sender is a product manager and is writing an e-mail about a product function requirement, the sending-end IM client terminal 604 may determine correlation between contact groups and the content of the e-mail through keywords or position attributes of contacts and the like.

Alternatively, the sending-end IM client terminal 604 may sort the at least one contact group according to a historical selection probability of the sender for the at least one contact group. In this way, it is feasible to push a contact group usually selected by the sender to the front, which is convenient for the sender to select preferentially. In specific implementation, the sending-end IM client terminal 604 may make statistics on selection probabilities of the sender for respective contact groups in a past period of time, and sort the respective contact groups based on the historical selection probabilities.

In an optional implementation mode, before using the at least one contact group, the sending-end IM client terminal 604 also needs to divide contacts of the sender into at least one contact group. For example, the sending-end IM client terminal 604 may divide contacts of the sender into at least one contact group according to recipient information of historical e-mails of the sender. The historical e-mails of the sender refer to e-mails sent by the sender before the contact group is formed. When the sender sends the historical e-mails, it is feasible to add the recipients one by one according to the conventional techniques. In general, for e-mails having different subjects or content, their recipients may be different; while for e-mails having the same or similar subjects or content, their recipients may generally be the same. Therefore, the sending-end IM client terminal 604 may determine similarity between contacts of the sender through making statistics and analysis on recipient information of historical e-mails of the sender, and then divide the contacts of the sender into different contact groups.

It is worth noting that information of the at least one contact group may be maintained by the sending-end IM client terminal 604 alone, and in this way, the sending-end IM client terminal 604 locally acquires contact groups, which helps to improve acquisition efficiency.

In another optional implementation mode, the sending-end IM client terminal 604 sends a group acquisition request to the server 602; and the sending-end IM client terminal 604 receives at least one contact group returned by the server 602. In the implementation manner, information of the at least one contact group is maintained by the server 602 in a unified way, which facilitates maintenance and management, and further reduces the load of the sending-end IM client terminal 604.

In the implementation mode that the server 602 maintains the contact group in a unified way, before returning at least one contact group to the sending-end IM client terminal, the server 602 sorts the at least one contact group and returns the sorted contact group to the sending-end IM client terminal 604.

A sorting manner is as follows: the server 602 may sort the at least one contact group in advance according to correlation between the at least one contact group and the content of the e-mail; in this way, it is feasible to push a contact group having higher correlation with the content of the e-mail to the front, which is convenient for the sender to select preferentially. In specific implementation, the server 602 may determine contacts or recipients according to content of a current e-mail. For example, if the sender is a product manager and is writing an e-mail about a product function requirement, the server 602 may determine correlation between contact groups and the content of the e-mail through keywords or position attributes of contacts and the like.

Another sorting manner is as follows: the server 602 may sort the at least one contact group according to a historical selection probability of the sender for the at least one contact group. In this way, it is feasible to push a contact group usually selected by the sender to the front, which is convenient for the sender to select preferentially. In specific implementation, the server 602 may make statistics on selection probabilities of the sender for respective contact groups in a past period of time, and sort the respective contact groups based on the historical selection probabilities.

In the implementation mode that the server 602 maintains the contact group, before returning at least one contact group to the sending-end IM client terminal 604, the server 602 also needs to divide contacts of the sender into at least one contact group. For example, the server 602 may divide contacts of the sender into at least one contact group according to recipient information of historical e-mails of the sender. The historical e-mails of the sender refer to e-mails sent by the sender before the contact group is formed. When the sender sends the historical e-mails, it is feasible to add the recipients one by one according to the conventional techniques. In general, for e-mails having different subjects or content, their recipients may be different, while for e-mails having the same or similar subjects or content, their recipients may generally be the same. Therefore, the server 602 may determine similarity between contacts of the sender through making statistics and analysis on recipient information of historical e-mails of the sender, and then divide the contacts of the sender into different contact groups.

Further, after adding the recipients, the sender may also delete the recipients, in order to finally determine the recipients of the e-mail. For example, the sender may send out a deleting instruction; the sending-end IM client terminal 604 receives the deleting instruction of the sender; and the sending-end IM client terminal 604 deletes a recipient corresponding to the deleting instruction from the recipient list.

In an implementation mode, the sender may directly operate an ID of a recipient in the recipient list to send out a deleting instruction. For example, the sender may click or double-click an ID of the recipient to send out a deleting instruction, or right-click the ID of the recipient to call a deleting option and send out a deleting instruction by clicking the deleting option. The sending-end IM client terminal 604 receives the deleting instruction sent out by the sender by operating an ID of a recipient of the e-mail in the recipient list.

In another implementation mode, when adding the recipient of the e-mail to the recipient list, the sending-end IM client terminal 604 displays a deleting button corresponding to the recipient of the e-mail in the recipient list. Thus, the sender may operate a deleting button corresponding to the recipient of the e-mail in the recipient list to send out a deleting instruction. For example, it is feasible to click a deleting button to send out a deleting instruction. The sending-end IM client terminal 604 receives the deleting instruction sent out by the sender by operating a deleting button corresponding to the recipient of the e-mail in the recipient list.

After determining the recipient of the e-mail and acquiring the content of the e-mail, the receiving-end IM client terminal 606 generates the e-mail; and then sends the e-mail to the server 602.

In this example embodiment, it is required that the recipient must be associated with an e-mail account, and the server 602 needs to forward an e-mail based on the e-mail account with which the recipient is associated; otherwise, the recipient cannot receive the e-mail sent by the sender. That the recipient is associated with an e-mail account refers to that the recipient associates a client terminal thereof used for conducting communication with the server 602 with at least one specified e-mail account.

Based on the above, after receiving an e-mail of a sender, the server 602 determines whether or not there exists a recipient that has not yet been associated with an e-mail account in the recipients of the e-mail. For example, it is feasible to generate an association list in advance, the association list storing IDs of associated users and e-mail accounts with which the associated users are associated. Based on this, the server 602 may match an ID of a recipient of the e-mail in the association list; if an ID of an associated user the same as the ID of the recipient of the e-mail is matched in the association list, the server 602 determines that the recipient of the e-mail has already been associated with an e-mail account, and may further acquire an e-mail account corresponding to the ID of the associated user matched as the e-mail account that the recipient has been associated with; and if no ID of an associated user the same as the ID of the recipient of the e-mail is matched in the association list, the server 602 determines that the recipient of the e-mail has not yet been associated with an e-mail account.

If it is determined that there exists a recipient that has not yet been associated with an e-mail account in the recipients of the e-mail, with respect to the recipient that has not yet been associated with an e-mail account, the server 602 temporarily allocates an e-mail account to the recipient that has not yet been associated with an e-mail account, and sends the e-mail to the allocated e-mail account, thereby ensuring that the recipient that has not yet been associated with an e-mail account may successfully receive the e-mail, which enables information of the sender to be successfully transmitted to the recipient and improves communication efficiency between the recipient and the sender.

Further, if it is determined that there exists a recipient that has already been associated with an e-mail account in the recipients of the e-mail, with respect to the recipient that has already been associated with an e-mail account, the server 602 directly sends the e-mail to the e-mail account with which the recipient that has already been associated with an e-mail account is associated.

It is worth noting that the recipient that has not yet been associated with an e-mail account refers to a recipient that has not yet associated a client terminal thereof used for conducting communication with the server 602 with a specified e-mail account; for such a recipient, the server 602 cannot forward an e-mail thereto. The recipient that has already been associated with an e-mail account refers to a recipient that has already associated a client terminal thereof used for conducting communication with the server 602 with a specified e-mail account; for such a recipient, the server 602 may forward an e-mail to the e-mail account with which the recipient is associated.

The server 602 sends a mail notification message to the receiving-end IM client terminal 606, to notify the recipient that has not yet been associated with an e-mail account to view the e-mail. It is worth noting that a communication way between the server 602 and the receiving-end IM client terminal 606 is an IM way.

For the receiving-end IM client terminal 606, it is not necessary to distinguish whether or not the recipient has already been associated with an e-mail account. After receiving the mail notification message sent by the server 602, the receiving-end IM client terminal 606 logs into the corresponding e-mail account according to the mail notification message to acquire the e-mail. With respect to the recipient that has not yet been associated with an e-mail account, the receiving-end IM client terminal 606 needs to log into the e-mail account allocated by the server 602 thereto, to acquire the e-mail. With respect to the recipient that has already been associated with an e-mail account, the receiving-end IM client terminal 606 needs to log into the e-mail account with which the recipient has already been associated, to acquire the e-mail.

Optionally, after receiving the mail notification message sent by the server 602, the receiving-end IM client terminal 606 may display the mail notification message to the recipient (herein, the recipient includes the recipient that has already been associated with an e-mail account and the recipient that has not yet been associated with an e-mail account) in the form of a message flow in a message flow list of a main page thereof, to notify the recipient that there is an e-mail to be read. In the implementation mode, after receiving an instruction of the recipient, the receiving-end IM client terminal 606 logs into the corresponding e-mail account according to the mail notification message, to acquire the e-mail. It is worth noting that the message low list of this example embodiment can display messages in various forms, including free business calls, call records, mail receiving and sending notification messages, approval task notification and so on.

It is worth noting that, with respect to the recipient that has not yet been associated with an e-mail account, one situation is that it is likely that the recipient has registered an IM account and installed an IM client terminal, but has not yet been associated with an e-mail account; and the other situation is that the recipient has not yet registered an IM account and has not been associated with an e-mail account.

For the latter, the server 602 further needs to send a registration notification message to the recipient that has not yet been associated with an e-mail account in a communication manner different from the receiving-end IM client terminal 606, to notify the recipient that has not yet been associated with an e-mail account to register an IM account. With respect to the recipient that has not yet been associated with an e-mail account and has not yet registered an IM account, according to the registration notification message, a registration request is sent to the server 602 through the receiving-end IM client terminal 606 thereof, and an IM account desired for registration is carried in the registration request. The server 602 receives the registration request sent by the receiving-end IM client terminal 606; and the server 602 returns a registration success response to the receiving-end IM client terminal 606.

The communication manner different from the receiving-end IM client terminal 606 may be another IM communication manner or a non-IM communication manner different from the receiving-end IM client terminal 606. For example, suppose that the receiving-end IM client terminal 606 is a Dingtalk client terminal, another IM communication manner different from the receiving-end IM client terminal 606 may be WeChat™, QQ or other communication manners; the non-IM communication manner different from the receiving-end IM client terminal 606 may be short message, telephone or other communication manners.

With respect to the recipient that has not yet been associated with an e-mail account and has not yet registered an IM account, if an IM client terminal has not yet been installed, it is feasible to firstly download and install the IM client terminal and then register at the server 602.

Optionally, in order to make the recipient more easily download and install the IM client terminal, the registration notification message sent by the server 602 may include a download address of the IM client terminal for the recipient that has not yet been associated with an e-mail account (the recipient that has not yet been associated with an e-mail account and has not yet registered an IM account) to download and install the IM client terminal. The IM client terminal after being installed is the receiving-end IM client terminal 606.

Further, after receiving a registration request from the recipient that has not yet been associated with an e-mail account and has not yet registered an IM account, the server 602 may obtain the IM account of the recipient and then establish an association relationship between the IM account of the recipient that has not yet been associated with an e-mail account and the allocated e-mail account.

Further, in the system according to this example embodiment, after allocating an e-mail account to the recipient that has not yet been associated with an e-mail account, the server 602 allows the recipient to make modification, to adapt to users' application requirements.

Based on the above, the server 602 may receive an e-mail account modification request sent by the receiving-end IM client terminal 606; and modify the allocated e-mail account according to the e-mail account modification request.

One specific modification manner is as follows: the recipient modifies the name of the e-mail account. Thus, the server 602, for example, modifies the name of the allocated e-mail account according to the e-mail account modification request. Optionally, the e-mail account modification request includes a target e-mail account name into which the name of the e-mail account is to be modified.

Another specific modification manner is as follows: the recipient hopes to replace the e-mail account allocated by the server 602 with another e-mail account. Thus, the server 602, for example, modifies the allocated e-mail account to another e-mail account according to the e-mail account modification request. Optionally, the e-mail account modification request may include a target e-mail account into which the e-mail account is to be modified.

In the system according to this example embodiment, a server receives an e-mail from a sender. If there exists a recipient that has not yet been associated with an e-mail account in the recipients of the e-mail, the server allocates an e-mail account to the recipient that has not yet been associated with an e-mail account, and sends the e-mail to the allocated e-mail account, thereby ensuring that a recipient may successfully receive an e-mail of a sender, which solves the problem that an e-mail cannot be received and improves communication efficiency between users.

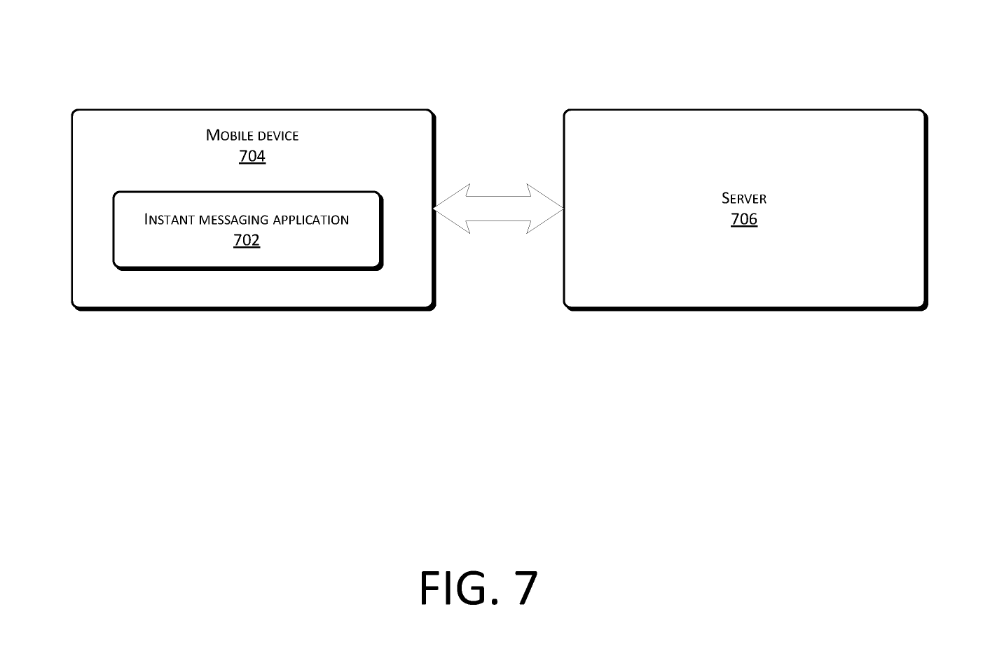

FIG. 7 is a schematic diagram of an application scenario according to an example embodiment of the present disclosure. As shown in FIG. 7, an instant messaging application 702 is installed in a mobile device 704, and a user may achieve instant messaging among multiple users through the instant messaging application 702. In more formal application scenarios, the user still needs to interact with other users or send a notification message to other users by using e-mail. The instant messaging application 702 in the related technology may be further integrated with an e-mail sending and receiving function and e-mail sending and receiving with other users is achieved through a server 706.

However, in conventional techniques, the user needs to manually add and generate an e-mail group. Especially when there are more group members, it will evidently waste lots of time and cost of the user and is very easy to lead to errors or omissions.

Therefore, the present disclosure solves the above technical problems existing in the conventional techniques through a process of automatically generating an e-mail group.

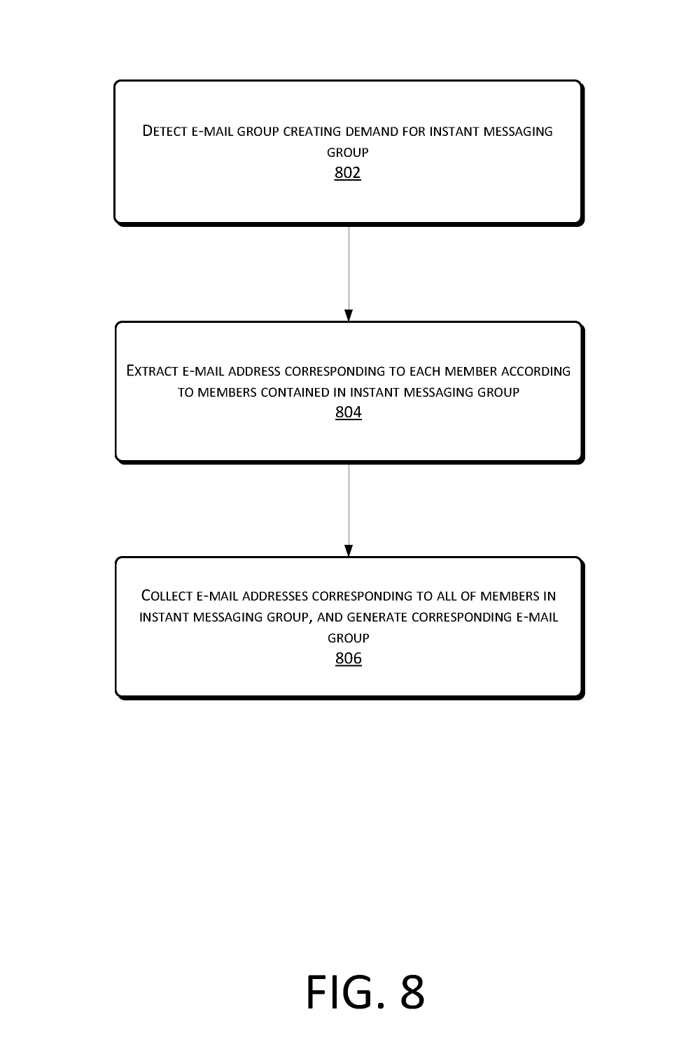

FIG. 8 is a flow chart of a method for creating an e-mail group according to an example embodiment of the present disclosure. The method may be applied to a server, and may include the following steps:

At 802, the server detects an e-mail group creating demand for an instant messaging group.

In this example embodiment, with constant development of the Internet, an instant messaging application has become a communication manner most widely used by people, and is increasingly applied to daily mobile office work. Therefore, combining the instant messaging application with an e-mail sending and receiving function is conductive to mobilization development of enterprise work and management, and facilitates a user to seamlessly switch between instant messaging and e-mail sending and receiving.

The instant messaging application may be any application program that achieves “instant messaging.” For example, it may be an Enterprise Instant Messaging (EIM), such as the EIM “Dingtalk”.

In this example embodiment, by detecting an e-mail group creating demand, it is feasible to intelligently detect a user demand and accordingly implement automatic creation of an e-mail group, which, on the one hand, meets a user's e-mail sending and receiving demand, and on the other hand, controls the generation time of the e-mail group, thereby avoiding that random generation of the e-mail group leads to too much pressure on the server.

At 804, the server extracts an e-mail address corresponding to each member according to members contained in the instant messaging group.

In this example embodiment, the present disclosure does not limit the type of the e-mail address corresponding to each member, and it is feasible to employ an e-mail address with any suffix.

At 806, the server collects the e-mail addresses corresponding to all of the members in the instant messaging group, and generates a corresponding e-mail group. When the e-mail group is used as a recipient of an e-mail, the e-mail is sent to each e-mail address in the e-mail group respectively.

1. The Type of the E-Mail Address

In the technical solution of the present disclosure, there is no limit to the type of the e-mail address, and any valid e-mail address may be automatically added to an e-mail group as long as the e-mail address is bound with the user.

As an example embodiment, the e-mail address may be an e-mail address generated by the server for a corresponding member. For example, when the instant messaging application is software developed by a certain company and the server through which e-mails are sent and received is a server of the same company, the e-mail address may be registered and generated by the user at the server of the company, and the type thereof may be embodied by the suffix name of the e-mail address. For example, when the e-mail address is “12345@xx.com”, the suffix is “xx.com”.

As another example embodiment, the e-mail address may be an e-mail address bound by the member for himself/herself which is received by the server, and the e-mail address may be a server of any company, for example, “12345@yy.com” and the like.

In the above example embodiments, through compatibility with various types of e-mail addresses, the user's freedom of choice may be enhanced, thereby making the user obtain better use experience.

2. Instant Messaging Group

According to different processes of generating an instant messaging group, different situations may exist for members of the instant messaging group.

As an example embodiment, members in an instant messaging group may be any member inside an enterprise, and the members may gather together based on the same interest or other reasons, so as to conduct communication through the instant messaging group.

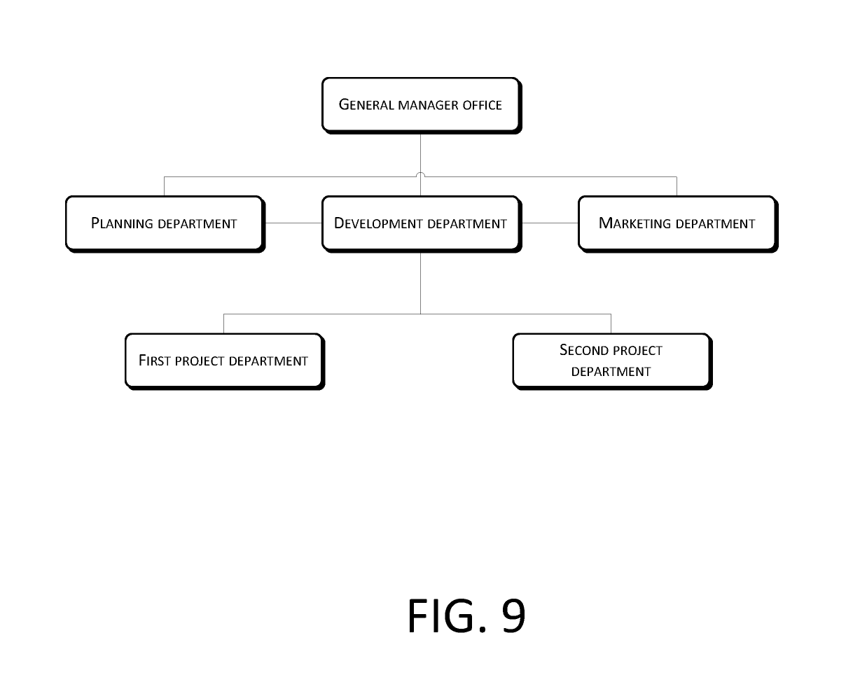

As another example embodiment, an instant messaging group may be automatically generated according to an organizational structure inside an enterprise. For example, if the organizational structure inside an enterprise is as shown in FIG. 9, it is feasible to automatically establish a corresponding instant messaging group for employees of departments under each level. For example, a “first project department” group is established for employees of a first project department, and the group includes all the employees of the first project department. A “development department” group is established for employees of a development department, and the group includes all the employees of all project departments of the development department, that is, all the employees of the first project department and the second project department.

It is feasible to import the organizational structure inside the enterprise when the instant messaging application is initially used at the first time, thereby generating respective instant messaging groups based on the organizational structure. Certainly, it is also feasible to perform an operation of importing the organizational structure at any other time. Each instant messaging group has a corresponding unique ID, and when the server generates an e-mail group corresponding to the instant messaging group, it is also feasible to use the unique ID to distinguish different e-mail groups. At the same time, when the organizational structure changes, for example, employees' addition, demission and the like, and departments' establishment, reorganization and the like, it is feasible to update the instant messaging groups and the e-mail groups accordingly, to ensure that data is interacted smoothly.

3. E-Mail Group Creating Demand

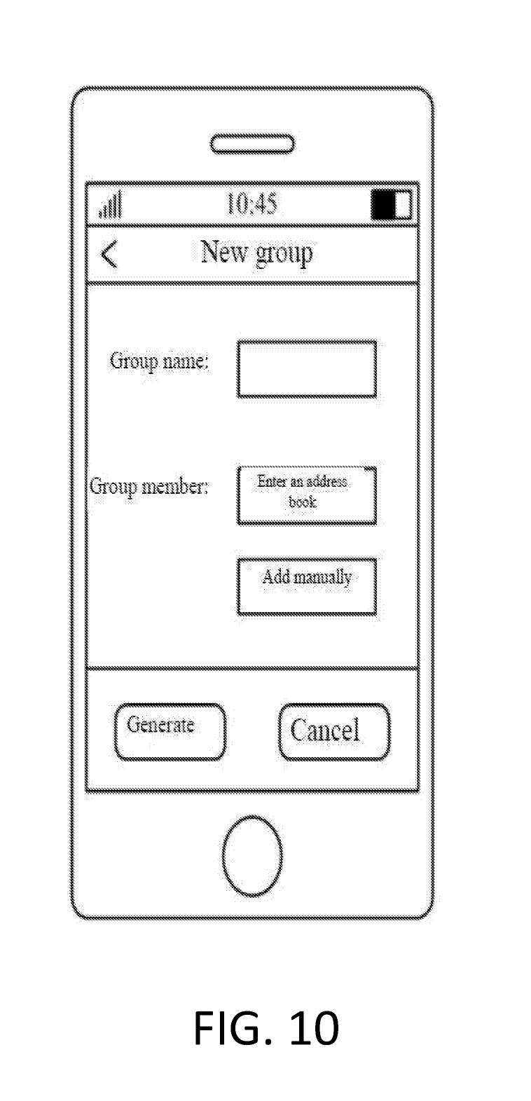

As one example embodiment, the server may, when detecting that an instant messaging group is created, determine that there is an e-mail group creating demand for the instant messaging group. As shown in FIG. 10, the user may, in an instant messaging application, create a new instant messaging group at any time, including a group name, group members and the like of the instant messaging group, all of which may be chosen freely. The group members may be friends from an address book of a mobile device (for example, an address book of a mobile phone and so on) or an instant messaging application, and may also be manually entered and added by the user. Then, after the user completes information filling-in and selection and triggers a “generate” key, it is feasible to determine that the e-mail group creating demand for the instant messaging group is triggered.

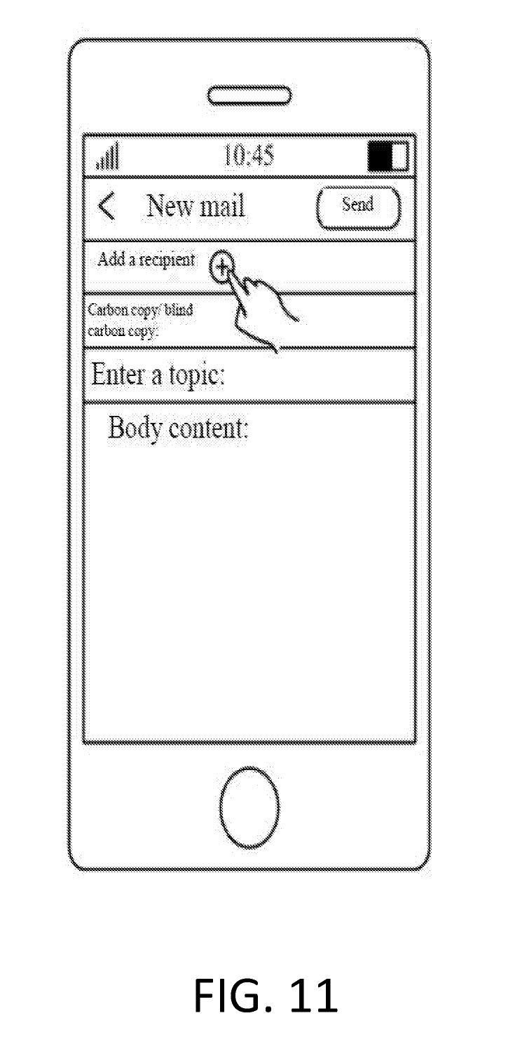

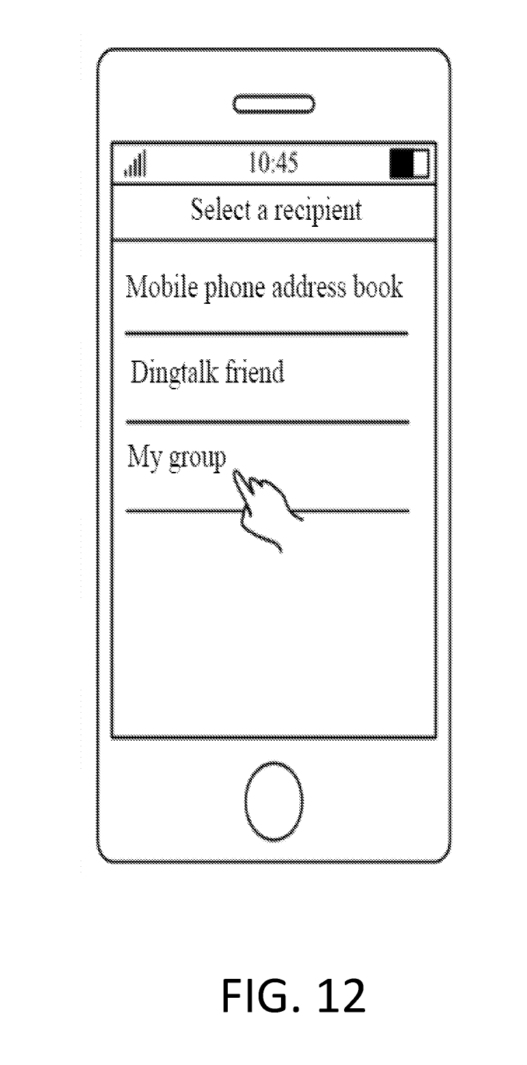

As another example embodiment, when, during an e-mail editing process of any user, receiving an instruction from such user to add the instant messaging group as an e-mail recipient, the server may determine that there is an e-mail group creating demand for the instant messaging group. As shown in FIG. 11, the user, during a process of editing an e-mail, may switch into a recipient selection page shown in FIG. 12 by triggering “Add a recipient” (for example, clicking ⊕ located on the right side of “Add a recipient” in FIG. 11), and the user may select any instant messaging group in “My Group”, to serve as a recipient of a current e-mail.

Therefore, even if the user creates an instant messaging group in advance, it is not necessary to establish a corresponding e-mail group as long as the user does not add the instant messaging group as an e-mail recipient, which helps to reduce the operating pressure of the server and avoids flooding of junk groups.

As a further example embodiment, the server may, during an e-mail editing process of any user, receive an instruction from such user to add the instant messaging group as an e-mail recipient, and receive an instruction from such user to send the corresponding e-mail. In this example embodiment, as the user may modify the recipient in the e-mail editing process, the user may remove a certain instant messaging group after adding the instant messaging group as a recipient, thereby leading to misjudgment on a demand for an e-mail group. Therefore, it is feasible to, after the user sends out a sending instruction for an e-mail, eliminate the possibility of modifying the recipient, thereby avoiding occurrence of the misjudgment, reducing the operating pressure of the server and avoiding flooding of junk groups.

4. Updating of Group Data

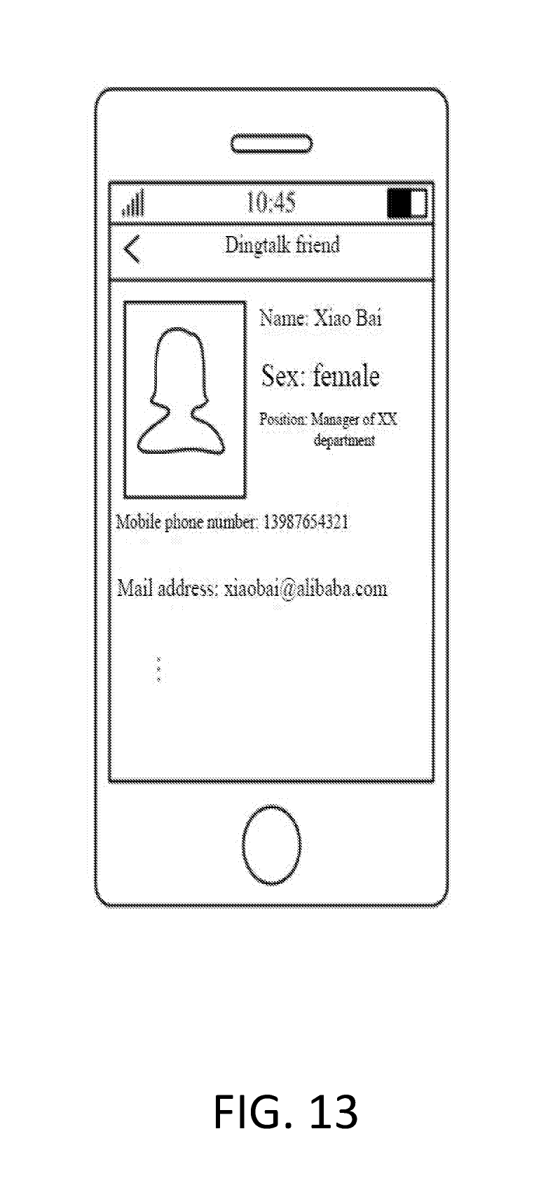

Suppose that the instant messaging application used by the user is “Dingtalk”, each instant messaging contact is a “Dingtalk friend.” For example, in FIG. 13, a contact “Xiao Bai” as a Dingtalk friend is illustrated. Suppose that “Xiao Bai” is “a manager of XX department” and belongs to an instant messaging group “XX department club.” When the server generates a corresponding e-mail group for the instant messaging group “XX department club”, it is feasible to extract a corresponding e-mail address from information of each contact. For example, the e-mail address of “Xiao Bai” is “xiaobai@alibaba.com”, and e-mail addresses of all users in the instant messaging group “XX department club” are collected to obtain an e-mail group.

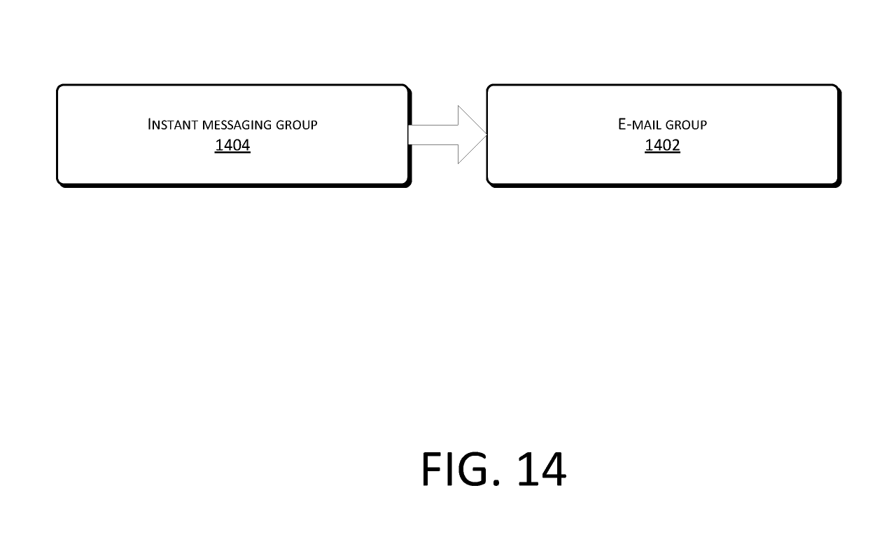

After the e-mail group is generated, as shown in FIG. 14, the server may maintain updating of data of the e-mail group 1402 according to data of the instant messaging group 1404. For example, the server may continuously acquire updated data of the corresponding instant messaging group, and, according to the updated data, update information of the e-mail group corresponding to the instant messaging group. The updated data may include at least one of the following: updated data of the members in the instant messaging group (for example, group members' addition, deletion and the like); and updated data of the e-mail address corresponding to each member in the instant messaging group. For example, when “Xiao Bai” changes the e-mail address to “xiaobai222@alibaba.com”, the server may update the e-mail address of “Xiao Bai” in the e-mail group hereby.

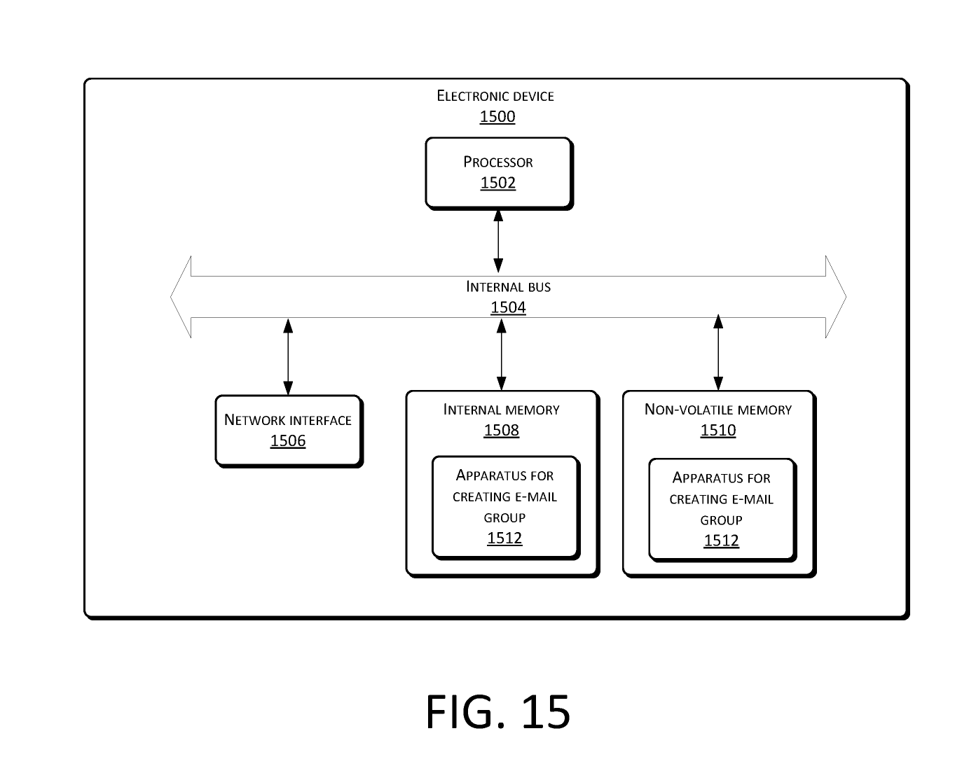

FIG. 15 is a schematic structural diagram of an electronic device according to an example embodiment of the present disclosure. Referring to FIG. 15, on a hardware level, the electronic device 1500 includes a processor 1502, an internal bus 1504, a network interface 1506, internal memory 1508 and a non-volatile memory 1510, and, certainly, may also include hardware required for other services. The processor reads, from the non-volatile memory, a corresponding computer program into the memory and then runs the computer program, to form an apparatus for creating an e-mail group 1512 on a logic level. Certainly, in addition to a software implementation manner, the present disclosure does not exclude other implementation manners, such as a logic device or a combination of software and hardware. That is to say, an execution body of the following processing flow is not limited to various logic units, which may also be hardware or a logic device.

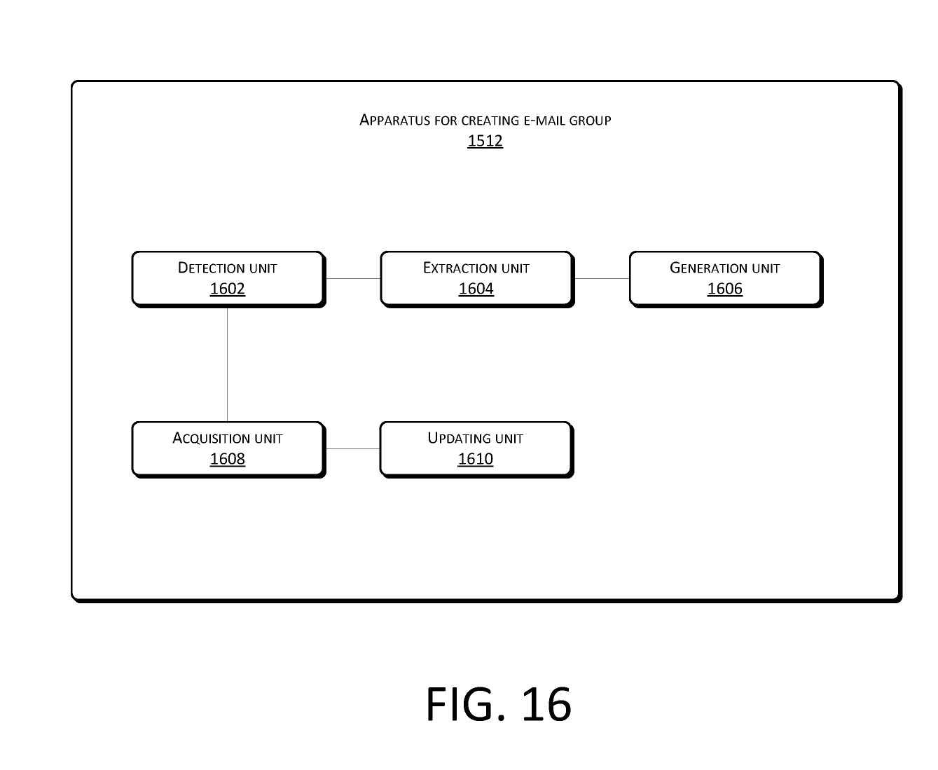

Referring to FIG. 16, in the software implementation manner, the apparatus for creating an e-mail group 1512 may include a detection unit 1602, an extraction unit 1604, and a generation unit 1606.

The detection unit 1602 detects an e-mail group creating demand for an instant messaging group.

The extraction unit 1604 extracts an e-mail address corresponding to each member according to members contained in the instant messaging group.

The generation unit 1606 collects the e-mail addresses corresponding to all the members in the instant messaging group, and generates a corresponding e-mail group. When the e-mail group is used as a recipient of an e-mail, the e-mail is sent to each e-mail address in the e-mail group respectively.

Optionally, the e-mail address includes at least one of the following:

an e-mail address generated by the server for a corresponding member; and

an e-mail address bound by the member for himself/herself which is received by the server.

Optionally, the detection unit 1602 may, for example, perform detecting that the instant messaging group is created.

Optionally, the detection unit 1602 may, for example, receive, during an e-mail editing process of any user, an instruction from such user that adds the instant messaging group as an e-mail recipient.

Optionally, the detection unit 1602 may, for example, receive, during an e-mail editing process of any user, an instruction from such user that adds the instant messaging group as an e-mail recipient, and receive an instruction from such user that sends the corresponding e-mail.

Optionally, the apparatus 1512 further includes:

an acquisition unit 1608 that acquires updated data of the instant messaging group; and

an updating unit 1610 that, according to the updated data, updates information of the e-mail group corresponding to the instant messaging group.

Optionally, the updated data includes at least one of the following:

updated data of the members in the instant messaging group; and

updated data of the e-mail address corresponding to each member in the instant messaging group.

Optionally, the instant messaging group is an enterprise instant messaging group.

In a typical configuration, a computation device includes one or more central processing units (CPUs), an input/output interface, a network interface, and a memory.

The memory may include the following forms of a computer readable medium: a volatile memory, a random access memory (RAM) and/or a non-volatile memory, for example, a read-only memory (ROM) or a flash RAM. The memory is an example of the computer readable medium.

The computer readable medium includes volatile and non-volatile, removable and non-removable media, and can use any method or technology to store information. The information may be a computer readable instruction, a data structure, and a module of a program or other data. Examples of storage media of a computer include, but are not limited to, a phase change memory (PRAM), a static random access memory (SRAM), a dynamic random access memory (DRAM), other types of RAMs, an ROM, an electrically erasable programmable read-only memory (EEPROM), a flash memory or other memory technologies, a compact disk read-only memory (CD-ROM), a digital versatile disc (DVD) or other optical storage, a cassette tape, a tape disk storage or other magnetic storage devices, or any other non-transmission media, which can be that storing information accessible to a computation device. According to the definition herein, the computer readable medium does not include transitory computer readable media (transitory media), for example, a modulated data signal and a carrier.

It should be further noted that terms “comprise”, “include” or any other variations thereof are intended to cover non-exclusive inclusion, so that processes, methods, goods or devices that include a series of elements not only include those elements, but also include other elements not explicitly listed, or further include elements inherent in the processes, methods, goods or devices. Without more restrictions, an element defined by the wording of “including a ...” does not preclude the further inclusion of other identical elements in the processes, methods, goods or devices that include the element.

Persons skilled in the art can clearly understand that, for convenient and concise description, reference may be made to the corresponding processes in the foregoing method example embodiments for specific working processes of the system, apparatus and unit described as above.

In the several example embodiments provided in the present disclosure, it should be understood that the system, apparatus and method disclosed may be implemented in another manner. The apparatus example embodiments described above are only examples. For example, division of the unit is merely division of a logical function and division in another manner may exist in actual implementation. For example, a plurality of units or components may be combined or integrated into another system, or some features may be ignored or not performed. In addition, the mutual coupling or direct coupling or communication connections displayed or discussed may be implemented by using some interfaces, and the indirect coupling or communication connections between the apparatuses or units may be implemented electrically, mechanically or in another form.

The units described as separate parts may or may not be physically separate, and parts displayed as units may or may not be physical units, may be located in one place, or may be distributed on a plurality of network units. Some or all of the units may be selected according to actual needs to achieve the objectives of the solutions of the example embodiments.

In addition, functional units in the example embodiments of the present disclosure may be integrated into one processing unit, or each of the units may physically exist alone, or two or more units are integrated into one unit. The integrated unit may be implemented in a form of hardware, or may be implemented in a form of hardware and a software functional unit.

The integrated unit implemented in the form of a software functional unit may be stored in a computer readable storage medium. The software functional unit is stored in a storage medium, and includes several instructions for instructing a computer device (which may be a personal computer, a server, or a network device) or a processor to perform a part of the steps of the methods described in the example embodiments of the present disclosure. The foregoing storage medium includes: any medium that can store program codes, such as a USB flash drive, a removable hard disk, a Read-Only Memory (ROM), a Random Access Memory (RAM), a magnetic disk, or an optical disc.

Finally, it should be noted that the above example embodiments are merely provided for describing the technical solutions of the present disclosure, but not intended to limit the present disclosure. It should be understood by those of ordinary skill in the art that although the present disclosure has been described in detail with reference to the foregoing example embodiments, modifications can be made to the technical solutions described in the foregoing example embodiments, or equivalent replacements can be made to some technical features in the technical solutions, while such modifications or replacements do not cause the essence of corresponding technical solutions to depart from the spirit and scope of the technical solutions of the example embodiments of the present disclosure.

What is claimed is:

1. A method comprising:
receiving, by a server, an e-mail to be sent to a recipient;
determining that the recipient is not associated with an e-mail account; and
assigning an allocated e-mail account to the recipient.

2. The method of claim 1, further comprising sending the e-mail to the allocated e-mail account.

3. The method of claim 1, wherein the determining that the recipient is not associated with the e-mail account includes:
matching an ID of the recipient to an association list, the association list storing one or more IDs of associated users and e-mail accounts with which the associated users are associated; and
determining that the recipient is not associated with the e-mail account, in response to determining that the ID of the recipient does not match any ID in the associated list.

4. The method of claim 1, further comprising sending a mail notification message to a receiving-end IM client terminal of the recipient to notify the recipient to check the e-mail.

5. The method of claim 4, wherein the mail notification message includes information to register the allocated e-mail account.

6. The method of claim 1, further comprising:
receiving an e-mail account modification request for the recipient; and
modifying the allocated e-mail account according to the e-mail account modification request.

7. The method of claim 6, wherein the modifying the allocated e-mail account includes modifying a name of the allocated e-mail account according to the e-mail account modification request.

8. The method of claim 7, wherein the modifying the allocated e-mail account includes modifying the allocated e-mail account to another e-mail account according to the e-mail account modification request.

9. The method of claim 1, further comprising:
determining that the recipient is not associated with an instant messaging (IM) account of an instant messaging application;
sending a registration notification message to the recipient in a communication manner different from the instant messaging application to notify the recipient to register the IM account.

10. The method of claim 9, wherein the registration notification message includes a download address of an IM client terminal of the IM application.

11. The method of claim 10, further comprising establishing an association relationship between the IM account and the allocated e-mail account.

12. The method of claim 1, wherein the receiving the e-mail includes receiving the e-mail sent by a sending-end IM client terminal of a sender.

13. The method of claim 1, further comprising:
acquiring a content of the e-mail;
determining the recipient of the e-mail; and
generating, by a sending-end IM client terminal, the e-mail according to the content of the e-mail and the recipient of the e-mail.

14. The method of claim 12, wherein the determining the recipient of the e-mail includes:
displaying, by the sending-end IM client terminal, at least one contact group;
receiving, by the sending-end IM client terminal, a selecting instruction sent by the sender, the selecting instruction being used for selecting a target contact group from the at least one contact group; and
using, by the sending-end IM client terminal, a contact in the target contact group as the recipient of the e-mail, and adding the contact to a recipient list of the e-mail.

15. A method comprising:
detecting, by a server, an e-mail group creating demand for an instant messaging group;
extracting one or more e-mail address corresponding to members contained in the instant messaging group; and
generating an e-mail group including the one or more email addresses.

16. The method of claim 15, wherein the one or more e-mail addresses include an e-mail address generated by the server for a corresponding member that is not associated with the e-mail address.

17. The method of claim 15, wherein the one or more e-mail addresses include an e-mail address associated with a member in the instant messaging group.

18. The method of claim 15, wherein the detecting the e-mail group creating demand for the instant messaging group includes receiving, an instruction of adding the instant messaging group as an e-mail recipient.

19. The method of claim 15, wherein the instant messaging group is an enterprise instant messaging group.

20. An apparatus comprising:
a detection unit that detects an e-mail group creating demand for an instant messaging group;
an extraction unit that extracts one or more e-mail address corresponding to members contained in the instant messaging group; and
a generation unit that generates an e-mail group including the one or more email addresses.
